(19) United States
(12) Patent Application Publication
(10) Pub. No.: US 2026/0257922 A1
(43) Pub. Date: Sep. 3, 2026

(54) SYSTEMS USEFUL FOR THE PRODUCTION OF HYDROGEN AND/OR CARBON DIOXIDE

(71) Applicant: Cambridge Enterprise Limited, Cambridge, Cambridgeshire (GB)

(72) Inventors: Robert Bruce Grant, Cambridge, Cambridgeshire (GB); Ewa Janina Marek, Cambridge, Cambridgeshire (GB); Stuart Ashley Scott, Cambridge, Cambridgeshire (GB)

(73) Assignee: Cambridge Enterprise Limited, Cambridge, Cambridgeshire (GB)

(21) Appl. No.: 19/489,458

(22) PCT Filed: May 29, 2024
(86) PCT No.: PCT/GB2024/051374

§ 371 Date: Dec. 2, 2025

(30) Foreign Application Priority Data
Jun. 2, 2023 (GB) 2308307.4

(51) Int. Cl. C01B 32/50; C01B 3/34

(52) U.S. Cl. CPC C01B 32/50; C01B 3/344

(57) ABSTRACT

A system comprising: a first vessel configured to convert a first fluid into a second fluid, and a second vessel configured to convert the second fluid into a third fluid,
wherein:
the first vessel comprises an output which is coupled to an input of the second vessel, and the first fluid comprises: a carbon containing compound, a hydrogen containing molecule that is not a hydrocarbon, or a combination of a carbon containing compound and a hydrogen containing molecule that is not a hydrocarbon.

### TECHNICAL FIELD

The invention relates to systems, vessels and processes. The systems, vessels and processes are particularly useful for the production of hydrogen and/or carbon dioxide.

### BACKGROUND OF INVENTION

Conventional hydrogen production systems usually fall into one of the following categories: electrolysis of water, high temperature water splitting, photobiological water splitting, photoelectrochemical water splitting, fermentation of carbohydrate feedstocks and natural gas reforming. Each of these systems is energy intensive and as such to ensure a return on investment, the resulting hydrogen must be priced accordingly (making it an expensive component in some industries). Furthermore, systems that produce hydrogen are usually large (to ensure scale and thus reduce costs as much as possible) and are therefore situated in geographical locations that are not necessarily near to the end consumers. This results in the produced hydrogen needing to be transported (often over vast distances) to industrial consumers or into a local gas network. A separate industry has evolved to manage this distribution and has its own associated drawbacks (for example, hydrogen is often transported in compressed liquid form using haulage vehicles which produce harmful emissions).

Conventional carbon dioxide productions systems usually work either by steam reforming methane or by adsorbing carbon dioxide from gas streams. When using a steam reforming of methane process, the process produces hydrogen as well as carbon monoxide (which can be converted to carbon dioxide via a water-gas shift reaction). However, because the availability and pricing of methane is heavily dependent on economic factors, it is often not cost effective to produce carbon dioxide using these methods (which results in carbon dioxide shortages or drastically increased costs). Furthermore, conventional carbon dioxide production systems often need to be situated in geographical locations that are not necessarily near to the end consumers which results in the need for the carbon dioxide to be liquified and transported over vast distances.

In some industries hydrogen or carbon dioxide is produced as a by-product of an industrial process or is present in an output stream (such as an output from a vacuum furnace). Usually, this fluid is treated as a waste product and the most economical solution is to dispose of it. For example, in industries that rely on vacuum furnaces, hydrogen and carbon dioxide is often present in the output gas stream. When hydrogen and/or carbon dioxide is in an output gas stream or is considered to be a waste product, it is usually combined with other low value gas streams and sent to a facility that deals specifically with disposing of this gas. Such facilities are usually located far away from the source of the waste gases and are primarily aimed at disposing of the gas at low cost. Alternatively, when a given industrial plant has its own on-site waste product processing facility, it is an integral part of the plant (usually designed and built when the plant is built). Such wate product processing facilities are difficult and expensive to retro fit to existing industrial facilities.

### SUMMARY OF INVENTION

The invention relates to systems, vessels and processes. The systems, vessels and processes are particularly useful for the production of hydrogen and/or carbon dioxide.

The inventors have developed systems, vessels and processes that are specifically designed to be particularly useful in industries that produce carbon containing fluid streams and/or hydrogen containing fluid streams. For example, some industries produce these fluids as by-products or they are part of their output streams (usually in low amounts). However, the inventors have identified that these conventional systems result in the disposal of the carbon or hydrogen containing components. As such, the systems described herein have been developed so that they are particularly useful to such industries.

The present invention is based on the discovery that it is not feasible for many industries to convert low value carbon containing and/or hydrogen containing fluids into high value fluids. Whilst it is known that some carbon containing and/or hydrogen containing fluids can be converted into other fluids (for example by using conventional metal oxide chemical looping reactions), these systems have not been used in industry as their output is low value and therefore it is not feasible for industries to do so. As such, the low value carbon containing and/or hydrogen containing fluids produced in industry are discarded (for example, they may be flared off). In contrast, the inventors have identified that it is possible to convert low value carbon containing and/or hydrogen containing fluids into high value fluids using the two-step systems, vessels and processes described herein.

Specifically, the systems, vessels and processes described herein are able to receive low value carbon containing and/or hydrogen containing fluids and covert them to high value fluids (such as food grade carbon dioxide or high purity hydrogen). For example, the systems, vessels and processes described herein can produce hydrogen at high purity/concentration as well as carbon dioxide at high purity/concentration. Many materials can be used in the systems, vessels and processes described herein and many of these are specifically identified herein, however, the invention is not limited to the use of such materials.

When using the systems, vessels and processes described herein, a first fluid (which can be derived from many different industrial processes) is converted into a second fluid. Depending on the constituents of the first fluid, the second fluid will contain some carbon dioxide and/or water. However, the second fluid will not be “pure” carbon dioxide and/or water. For example, when the first fluid comprises a carbon containing compound, the second fluid will contain carbon dioxide and some additional fluids such as some of the unconverted carbon containing compound and/or partially oxidised counterparts of the carbon containing compound (sometimes known as slippage gases). The more of these impurities that are in the second fluid, the lower value this fluid is considered. Therefore, the second fluid is converted into a third fluid which has a higher concentration of carbon dioxide (for example by using a second vessel/material which converts some of the impurity into carbon dioxide), thereby producing a high value third fluid.

Similarly, when the first fluid comprises a hydrogen containing molecule described herein, the second fluid will comprise water and some additional fluids such as some of the unconverted hydrogen containing molecule and/or partially oxidised counterparts of the hydrogen containing molecule. Therefore, the second fluid is converted to a third fluid which has a higher concentration of water (for example by using a second vessel/material which converts some of the impurity into water), thereby producing a high value third fluid.

Additionally, by converting a first fluid into a second fluid, the state of the vessel/material is changed so that it is capable of splitting water. For example, a metal oxide may be reduced by the first fluid to form a reduced metal oxide. By contacting the reduced material with a fluid comprising water, high value hydrogen may be produced.

Such systems are particularly useful because they can be implemented “on-site”. That is, they may be deployed in a specific facility and convert the low value carbon containing and/or hydrogen containing fluids to high value fluids (without the need for large and expensive scrubbing apparatus or disposing apparatus). As such, the present systems, vessels and processes represent a significant improvement on conventional counterparts used in these industries.

Other features and advantages of the invention are described throughout the specification. For example, the systems, vessels and processes described herein are able to be provided in a single fitting (such as in a single container) reducing the need to substantially redesign/restructure an existing manufacturing plant. They may also be moved between sites to meet demand. Such an “in the box” solution is not currently available in conventional industry. Furthermore, the present invention removes the need to liquify the resulting hydrogen and/or carbon dioxide as it can be produced “on site” and on demand. Liquifying hydrogen and/or carbon dioxide on site may be considered too expensive/difficult for many industrial users and as such would not be considered commercially viable. Additionally, or alternatively, the present invention can produce hydrogen and/or carbon dioxide from low value fluid streams and store them for later sale (rather than disposing of them). The present systems are also able to process very low concentration fluid streams and/or operate at significantly lower temperatures than conventional process, thereby increasing the cost effectiveness of an industrial process.

In a first aspect, the invention relates to a system comprising:
a first vessel configured to convert a first fluid into a second fluid, and
a second vessel configured to convert the second fluid into a third fluid,
wherein:
the first vessel comprises an output which is coupled to an input of the second vessel,
the first fluid comprises:
   a carbon containing compound,
   a hydrogen containing molecule that is not a hydrocarbon, or
   a combination of a carbon containing compound and a hydrogen containing molecule that is not a hydrocarbon;
   (i) when the first fluid comprises a carbon containing compound:
      the second fluid comprises carbon dioxide and at least one impurity;
      the third fluid comprises carbon dioxide and optionally at least one impurity; and
      the concentration of carbon dioxide in the third fluid is greater than the concentration of carbon dioxide in the second fluid;
   (ii) when the first fluid comprises a hydrogen containing molecule that is not a carbon containing compound:
      the second fluid comprises water, and at least one impurity;
      the third fluid comprises water and optionally at least one impurity; and
      the concentration of water in the third fluid is greater than the concentration of water in the second fluid;
   (iii) when the first fluid comprises a combination of a carbon containing compound and a hydrogen containing molecule that is not a carbon containing compound:
      the second fluid comprises carbon dioxide, water, and at least one impurity;
      the third fluid comprises carbon dioxide, water and optionally at least one impurity; and
      the concentration of carbon dioxide in the third fluid is greater than the concentration of carbon dioxide in the second fluid.

In some embodiments, the first fluid comprises a carbon containing compound; the second fluid comprises carbon dioxide and at least one impurity; the third fluid comprises carbon dioxide and optionally at least one impurity; and the concentration of carbon dioxide in the third fluid is greater than the concentration of carbon dioxide in the second fluid,

In some embodiments, the first fluid comprises a hydrogen containing molecule that is not a hydrocarbon; the second fluid comprises water, and at least one impurity;
the third fluid comprises water and optionally at least one impurity; and the concentration of water in the third fluid is greater than the concentration of water in the second fluid.

In some embodiments, the first fluid comprises a combination of a carbon containing compound and a hydrogen containing molecule that is not a hydrocarbon; the second fluid comprises carbon dioxide, water, and at least one impurity; the third fluid comprises carbon dioxide, water and optionally at least one impurity; and the concentration of carbon dioxide in the third fluid is greater than the concentration of carbon dioxide in the second fluid.

In some embodiments, the first vessel is a reaction vessel, optionally a combustion vessel.

In some embodiments, the first vessel comprises an output which is directly coupled to the input of the second vessel.

In some embodiments, the first vessel comprises a first material which is configured to convert the first fluid into the second fluid.

In some embodiments, the first material is a metal oxide or a combination of metal oxides; optionally the metal of each of the metal oxides is independently selected from the group consisting of transition metals, lanthanides, and mixtures thereof.

In some embodiments, the second vessel is a reaction vessel, optionally a combustion vessel such as a chemical looping combustion vessel.

In some embodiments, the second vessel comprises a second material which is configured to convert the second fluid into the third fluid.

In some embodiments, the second material is a metal oxide or a combination of metal oxides; optionally the metal of each of the metal oxides is independently selected from the group consisting of transition metals, lanthanides, and mixtures thereof.

In some embodiments, the first vessel and second vessel are in close proximity; optionally the first vessel and the second vessel are within about 10 metres of each other.

In some embodiments, the first fluid is a fluid from an industrial process.

In some embodiments, the carbon containing compound is an organic compound with a boiling point (at standard temperature and pressure) of below about 300° C.

In some embodiments, the carbon containing compound is selected from the group consisting of substituted or unsubstituted alkanes, substituted or unsubstituted alkenes, substituted or unsubstituted alkynes, substituted or unsubstituted alcohols, substituted or unsubstituted ketones, substituted or unsubstituted aldehydes, substituted or unsubstituted amides, substituted or unsubstituted carboxylic acids, substituted or unsubstituted esters, substituted or unsubstituted carbocyclic compounds, substituted or unsubstituted aromatic compounds, substituted or unsubstituted heteroaromatic compounds, carbon monoxide, carbon dioxide and mixtures thereof.

In some embodiments, the hydrogen containing molecule that is not a hydrocarbon is selected from the group consisting of hydrogen, ammonia, metal hydrides and mixtures thereof.

In some embodiments, the first fluid comprises an auxiliary fluid; optionally wherein the auxiliary fluid comprises one or more carrier fluids and/or one or more auxiliary impurities.

In some embodiments, the at least one impurity is selected from the group consisting of a carbon containing compound, a hydrogen containing molecule that is not a hydrocarbon, an auxiliary fluid and mixtures thereof.

In some embodiments, the first vessel is configured to operate in a first state or in a second state;
when the first vessel is configured to operate in the first state, the first vessel is configured to convert the first fluid into the second fluid;
when the first vessel is configured to operate in the second state, the first vessel is configured to convert a fourth fluid into a fifth fluid;
wherein
the fourth fluid comprises water; and
the fifth fluid comprises hydrogen.

In a second aspect, the invention relates to a vessel comprising:
an input,
an output,
a first material, and
a second material;
wherein:
   the first material is positioned between the input and the output,
   the second material is positioned between the input and the output,
   the first material is configured to convert a first fluid into a second fluid,
   the second material is configured to convert the second fluid into a third fluid, and
   the first fluid comprises:
   a carbon containing compound,
   a hydrogen containing molecule that is not a hydrocarbon, or
   a combination of a carbon containing compound and a hydrogen containing molecule that is not a hydrocarbon;
   (i) when the first fluid comprises a carbon containing compound:
   the second fluid comprises carbon dioxide and at least one impurity;
   the third fluid comprises carbon dioxide and optionally at least one impurity; and
   the concentration of carbon dioxide in the third fluid is greater than the concentration of carbon dioxide in the second fluid;
   (ii) when the first fluid comprises a hydrogen containing molecule that is not a carbon containing compound:
   the second fluid comprises water, and at least one impurity;
   the third fluid comprises water and optionally at least one impurity; and
   the concentration of water in the third fluid is greater than the concentration of water in the second fluid;
   (iii) when the first fluid comprises a combination of a carbon containing compound and a hydrogen containing molecule that is not a carbon containing compound:
   the second fluid comprises carbon dioxide, water, and at least one impurity;
   the third fluid comprises carbon dioxide, water and optionally at least one impurity; and
   the concentration of carbon dioxide in the third fluid is greater than the concentration of carbon dioxide in the second fluid.

In a third aspect, the invention relates to a process, the process comprising the steps of:
contacting a first fluid with a first material in a first vessel to produce a second fluid, and contacting the second fluid with a second material in a second vessel to produce a third fluid;
wherein:
   the first fluid comprises:
   a carbon containing compound,
   a hydrogen containing molecule that is not a hydrocarbon, or
   a combination of a carbon containing compound and a hydrogen containing molecule that is not a hydrocarbon;
   (i) when the first fluid comprises a carbon containing compound:
   the second fluid comprises carbon dioxide and at least one impurity;
   the third fluid comprises carbon dioxide and optionally at least one impurity; and
   the concentration of carbon dioxide in the third fluid is greater than the concentration of carbon dioxide in the second fluid;
   (ii) when the first fluid comprises a hydrogen containing molecule that is not
   a carbon containing compound:
   the second fluid comprises water, and at least one impurity;
   the third fluid comprises water and optionally at least one impurity; and
   the concentration of water in the third fluid is greater than the concentration of water in the second fluid;
   (iii) when the first fluid comprises a combination of a carbon containing compound and a hydrogen containing molecule that is not a carbon containing compound:
   the second fluid comprises carbon dioxide, water, and at least one impurity;
   the third fluid comprises carbon dioxide, water and optionally at least one impurity; and
   the concentration of carbon dioxide in the third fluid is greater than the concentration of carbon dioxide in the second fluid.

In a fourth aspect, the invention relates to a process, the process comprising the steps of:
contacting a first fluid with a first material in a vessel to produce a second fluid, and
contacting the second fluid with a second material in the vessel to produce a third fluid;
wherein:
   the first fluid comprises:
   a carbon containing compound,
   a hydrogen containing molecule that is not a hydrocarbon, or
   a combination of a carbon containing compound and a hydrogen containing
   molecule that is not a hydrocarbon;
   (i) when the first fluid comprises a carbon containing compound:
   the second fluid comprises carbon dioxide and at least one impurity;
   the third fluid comprises carbon dioxide and optionally at least one impurity; and
   the concentration of carbon dioxide in the third fluid is greater than the concentration of carbon dioxide in the second fluid;
   (ii) when the first fluid comprises a hydrogen containing molecule that is not a carbon containing compound:
   the second fluid comprises water, and at least one impurity;
   the third fluid comprises water and optionally at least one impurity; and
   the concentration of water in the third fluid is greater than the concentration of water in the second fluid;
   (iii) when the first fluid comprises a combination of a carbon containing compound and a hydrogen containing molecule that is not a carbon containing compound:
   the second fluid comprises carbon dioxide, water, and at least one impurity;
   the third fluid comprises carbon dioxide, water and optionally at least one impurity; and
   the concentration of carbon dioxide in the third fluid is greater than the concentration of carbon dioxide in the second fluid.

In some embodiments, there is provided the vessel according to the second aspect, the process according to the third aspect, or the process according to the fourth aspect wherein,
the first material is as defined herein;
the second material is as defined herein;
the first fluid is as defined herein;
the carbon containing compound is as defined herein;
the hydrogen containing molecule that is not a hydrocarbon is as defined herein;
and/or
the at least one impurity is as defined herein.

In a fifth aspect, the invention relates to a use of a system described herein, for example for producing carbon dioxide and/or hydrogen.

In a sixth aspect, the invention relates to a use of a vessel described herein, for example for producing carbon dioxide and/or hydrogen.

In a seventh aspect, the invention relates to a process of producing carbon dioxide and/or hydrogen using a system described herein.

In an eighth aspect, the invention relates to a process of producing carbon dioxide and/or hydrogen using a vessel described herein.

In a ninth aspect, the invention relates to a container or building comprising a system and/or vessel as described herein.

### BRIEF DESCRIPTION OF DRAWINGS

The present invention will now be described with reference to the accompanying drawings, in which:

FIG. 1 is a schematic of system according to an embodiment described herein.

FIGS. 2 to 4 are schematics of vessels according to various embodiments described herein.

FIG. 5 is a schematic of a thermogravimetric analyser setup described herein.

FIGS. 6 to 34 are graphs showing the thermogravimetric results of experiments described herein.

FIG. 35 is a schematic of a packed bed reactor setup described herein.

FIGS. 36 to 40 are graphs showing the packed bed reactor results of experiments described herein.

### DETAILED DESCRIPTION

The invention relates to systems, vessels and processes. The systems, vessels and processes are particularly useful for the production of carbon dioxide and/or hydrogen.

### System

In a first aspect, the invention relates to a system comprising:
a first vessel configured to convert a first fluid into a second fluid, and
a second vessel configured to convert the second fluid into a third fluid,
wherein:
the first vessel comprises an output which is coupled to an input of the second vessel,
the first fluid comprises:
   a carbon containing compound,
   a hydrogen containing molecule that is not a hydrocarbon, or
   a combination of a carbon containing compound and a hydrogen containing
   molecule that is not a hydrocarbon;
   (i) when the first fluid comprises a carbon containing compound:
   the second fluid comprises carbon dioxide and at least one impurity;
   the third fluid comprises carbon dioxide and optionally at least one impurity; and
      the concentration of carbon dioxide in the third fluid is greater than the concentration of carbon dioxide in the second fluid;
   (ii) when the first fluid comprises a hydrogen containing molecule that is not a carbon containing compound:
      the second fluid comprises water, and at least one impurity;
      the third fluid comprises water and optionally at least one impurity; and
      the concentration of water in the third fluid is greater than the concentration of water in the second fluid;
   (iii) when the first fluid comprises a combination of a carbon containing compound and a hydrogen containing molecule that is not a carbon containing compound:
      the second fluid comprises carbon dioxide, water, and at least one impurity;
      the third fluid comprises carbon dioxide, water and optionally at least one impurity; and
      the concentration of carbon dioxide in the third fluid is greater than the concentration of carbon dioxide in the second fluid.

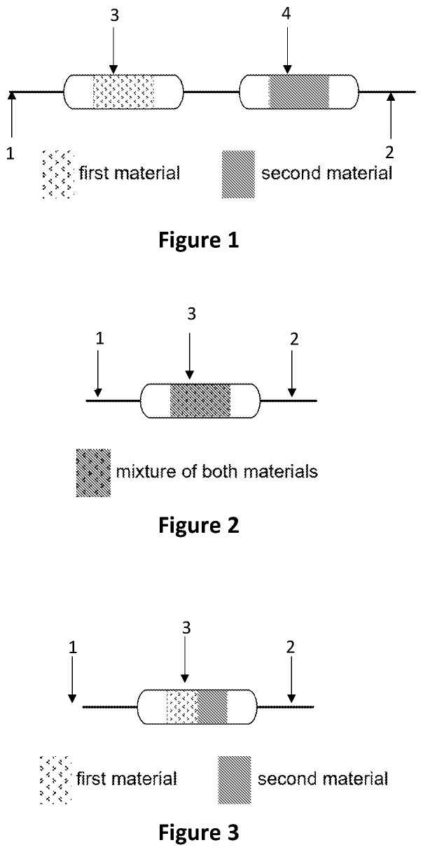

FIG. 1 is a system of the invention, showing a first vessel (3) and a second vessel (4) as well as an input (1) and an output (2).

### First Fluid

In some embodiments, the first fluid is a fluid from an industrial process. In some embodiments, the first fluid is a waste fluid or by-product from an industrial process.

For example, the industrial process may be a steel manufacturing process, metal processing process, organic compound production process, cosmetic industry process, semiconductor manufacturing process, semiconductor processing process, biogas production process and/or a biogas processing process.

In some embodiments, the first fluid is an organic solvent or reducing gas (such as one from an industrial process). For example, the first fluid is a waste/by-product organic solvent or reducing gas (such as one from an industrial process).

The first fluid comprises a carbon containing compound, a hydrogen containing molecule that is not a hydrocarbon, or a combination of a carbon containing compound and a hydrogen containing molecule that is not a hydrocarbon. In some embodiments, the first fluid consists of a carbon containing compound, a hydrogen containing molecule that is not a hydrocarbon, or a combination of a carbon containing compound and a hydrogen containing molecule that is not a hydrocarbon.

In some embodiments, the first fluid comprises an auxiliary fluid. In some embodiments, the first fluid comprises a carbon containing compound and an auxiliary fluid; a hydrogen containing molecule that is not a hydrocarbon and an auxiliary fluid; or a combination of a carbon containing compound, a hydrogen containing molecule that is not a hydrocarbon and an auxiliary fluid.

In some embodiments, the first fluid consists of carbon containing compound and an auxiliary fluid; a hydrogen containing molecule that is not a hydrocarbon and an auxiliary fluid; or a combination of a carbon containing compound, a hydrogen containing molecule that is not a hydrocarbon and an auxiliary fluid.

In all embodiments, the sum of the components in the first fluid does not exceed 100 vol %.

In some embodiments, the first fluid comprises from about 0.1 vol % to about 100 vol % of the carbon containing compound.

In some embodiments, the first fluid comprises from about 0.1 vol % to about 100 vol %, about 99 vol %, about 95 vol %, about 90 vol %, about 80 vol %, about 70 vol %, about 60 vol %, about 50 vol %, about 40 vol %, about 30 vol %, about 20 vol %, about 10 vol %, or about 5 vol % of the carbon containing compound.

In some embodiments, the first fluid comprises from about 0.1 vol %, about 1 vol %, about 2 vol %, about 5 vol %, about 10 vol %, about 20 vol %, about 30 vol %, about 40 vol %, about 50 vol %, about 60 vol %, about 70 vol %, about 80 vol %, or about 90 vol %, to about 100 vol % of the carbon containing compound.

In some embodiments, the first fluid comprises from about 0.1 vol % to about 100 vol % of the hydrogen containing molecule that is not a hydrocarbon.

In some embodiments, the first fluid comprises from about 0.1 vol % to about 100 vol %, about 99 vol %, about 95 vol %, about 90 vol %, about 80 vol %, about 70 vol %, about 60 vol %, about 50 vol %, about 40 vol %, about 30 vol %, about 20 vol %, about 10 vol %, or about 5 vol % of the hydrogen containing molecule that is not a hydrocarbon.

In some embodiments, the first fluid comprises from about 0.1 vol %, about 1 vol %, about 2 vol %, about 5 vol %, about 10 vol %, about 20 vol %, about 30 vol %, about 40 vol %, about 50 vol %, about 60 vol %, about 70 vol %, about 80 vol %, or about 90 vol %, to about 100 vol % of the hydrogen containing molecule that is not a hydrocarbon.

In some embodiments, the first fluid comprises from about 0.1 vol % to about 100 vol % of a combination of the carbon containing compound and the hydrogen containing molecule that is not a hydrocarbon.

In some embodiments, the first fluid comprises from about 0.1 vol % to about 100 vol %, about 99 vol %, about 95 vol %, about 90 vol %, about 80 vol %, about 70 vol %, about 60 vol %, about 50 vol %, about 40 vol %, about 30 vol %, about 20 vol %, about 10 vol %, or about 5 vol % of a combination of the carbon containing compound and the hydrogen containing molecule that is not a hydrocarbon.

In some embodiments, the first fluid comprises from about 0.1 vol %, about 1 vol %, about 2 vol %, about 5 vol %, about 10 vol %, about 20 vol %, about 30 vol %, about 40 vol %, about 50 vol %, about 60 vol %, about 70 vol %, about 80 vol %, or about 90 vol %, to about 100 vol % of a combination of the carbon containing compound and the hydrogen containing molecule that is not a hydrocarbon.

When the first fluid comprises a combination of a carbon containing compound and a hydrogen containing molecule that is not a hydrocarbon, each of the carbon containing compound and a hydrogen containing molecule that is not a hydrocarbon may independently be present in a vol % as described herein.

In some embodiments, the first fluid comprises from about 0.1 vol % to about 99.9 vol % of an auxiliary fluid.

In some embodiments, the first fluid comprises from about 0.1 vol % to about 99.9 vol %, about 99 vol %, about 95 vol %, about 90 vol %, about 80 vol %, about 70 vol %, about 60 vol %, about 50 vol %, about 40 vol %, about 30 vol %, about 20 vol %, about 10 vol %, or about 5 vol % of the auxiliary fluid.

In some embodiments, the first fluid comprises from about 1 vol %, about 2 vol %, about 5 vol %, about 10 vol %, about 20 vol %, about 30 vol %, about 40 vol %, about 50 vol %, about 60 vol %, about 70 vol %, about 80 vol %, or about 90 vol %, to about 99.9 vol % of the auxiliary fluid.

In some embodiments, the first fluid comprises from about 0.1 vol % to about 99 vol %, about 95 vol %, about 90 vol %, about 80 vol %, about 70 vol %, about 60 vol %, about 50 vol %, about 40 vol %, about 30 vol %, about 20 vol %, about 10 vol %, or about 5 vol % of water.

### Carbon Containing Compound

In some embodiments, the carbon containing compound is an organic compound with a boiling point (at standard temperature and pressure) of below about 300° C., optionally below about 250° C., below about 200° C., or below about 180° C. The carbon containing compound may be an organic compound with a boiling point (at standard temperature and pressure) of above −200° C., optionally above about −190° C., above about −180° C., or above about −170° C.

In some embodiments, the carbon containing compound is selected from the group consisting of substituted or unsubstituted alkanes, substituted or unsubstituted alkenes, substituted or unsubstituted alkynes, substituted or unsubstituted alcohols, substituted or unsubstituted ketones, substituted or unsubstituted aldehydes, substituted or unsubstituted amides, substituted or unsubstituted carboxylic acids, substituted or unsubstituted esters, substituted or unsubstituted carbocyclic compounds, substituted or unsubstituted aromatic compounds, substituted or unsubstituted heteroaromatic compounds, carbon monoxide, carbon dioxide and mixtures thereof.

In some embodiments, the carbon containing compound is selected from the group consisting of substituted or unsubstituted C₁-C₁₀ alkanes, substituted or unsubstituted C₂-C₁₀ alkenes, substituted or unsubstituted C₂-C₁₀ alkynes, substituted or unsubstituted C₂-C₁₀ alcohols, substituted or unsubstituted C₂-C₁₀ ketones, substituted or unsubstituted C₂-C₁₀ aldehydes, substituted or unsubstituted C₂-C₁₀ amides, substituted or unsubstituted C₂-C₁₀ carboxylic acids, substituted or unsubstituted C₂-C₁₀ esters, substituted or unsubstituted C₅-C₁₀ carbocyclic compounds, substituted or unsubstituted C₅-C₁₀ aromatic compounds, substituted or unsubstituted C₅-C₁₀ heteroaromatic compounds, carbon monoxide, carbon dioxide and mixtures thereof. For example, the carbon containing compound may be selected from the group consisting of substituted or unsubstituted C₁-C₈ alkanes, substituted or unsubstituted C₂-C₈ alkenes, substituted or unsubstituted C₂-C₈ alkynes, substituted or unsubstituted C₂-C₈ alcohols, substituted or unsubstituted C₂-C₈ ketones, substituted or unsubstituted C₂-C₈ aldehydes, substituted or unsubstituted C₂-C₈ amides, substituted or unsubstituted C₂-C₈ carboxylic acids, substituted or unsubstituted C₂-C₈ esters, substituted or unsubstituted C₅-C₈ carbocyclic compounds, substituted or unsubstituted C₅-C₈ aromatic compounds, substituted or unsubstituted C₅-C₈ heteroaromatic compounds, carbon monoxide, carbon dioxide and mixtures thereof. For example, the carbon containing compound may be selected from the group consisting of substituted or unsubstituted C₁-C₅ alkanes, substituted or unsubstituted C₂-C₅ alkenes, substituted or unsubstituted C₂-C₅ alkynes, substituted or unsubstituted C₁-C₅ alcohols, substituted or unsubstituted C₂-C₅ ketones, substituted or unsubstituted C₂-C₅ aldehydes, substituted or unsubstituted C₂-C₅ amides, substituted or unsubstituted C₂-C₅ carboxylic acids, substituted or unsubstituted C₂-C₅ esters, substituted or unsubstituted C₅-C₈ carbocyclic compounds, substituted or unsubstituted C₅-C₈ aromatic compounds, substituted or unsubstituted C₅-C₈ heteroaromatic compounds, carbon monoxide, carbon dioxide and mixtures thereof.

In some embodiments, the carbon containing compound is selected from the group consisting of substituted or unsubstituted C₂-C₁₀ alkanes, substituted or unsubstituted C₂-C₁₀ alkenes, substituted or unsubstituted C₂-C₁₀ alkynes, substituted or unsubstituted C₂-C₁₀ alcohols, substituted or unsubstituted C₂-C₁₀ ketones, substituted or unsubstituted C₂-C₁₀ aldehydes, substituted or unsubstituted C₂-C₁₀ amides, substituted or unsubstituted C₂-C₁₀ carboxylic acids, substituted or unsubstituted C₂-C₁₀ esters, substituted or unsubstituted C₅-C₁₀ carbocyclic compounds, substituted or unsubstituted C₅-C₁₀ aromatic compounds, substituted or unsubstituted C₅-C₁₀ heteroaromatic compounds, carbon monoxide, carbon dioxide and mixtures thereof. For example, the carbon containing compound may be selected from the group consisting of substituted or unsubstituted C₂-C₈ alkanes, substituted or unsubstituted C₂-C₈ alkenes, substituted or unsubstituted C₂-C₈ alkynes, substituted or unsubstituted C₂-C₈ alcohols, substituted or unsubstituted C₂-C₈ ketones, substituted or unsubstituted C₂-C₈ aldehydes, substituted or unsubstituted C₂-C₈ amides, substituted or unsubstituted C₂-C₈ carboxylic acids, substituted or unsubstituted C₂-C₈ esters, substituted or unsubstituted C₅-C₈ carbocyclic compounds, substituted or unsubstituted C₅-C₈ aromatic compounds, substituted or unsubstituted C₅-C₈ heteroaromatic compounds, carbon monoxide, carbon dioxide and mixtures thereof. For example, the carbon containing compound may be selected from the group consisting of substituted or unsubstituted C₂-C₅ alkanes, substituted or unsubstituted C₂-C₅ alkenes, substituted or unsubstituted C₂-C₅ alkynes, substituted or unsubstituted C₁-C₅ alcohols, substituted or unsubstituted C₂-C₅ ketones, substituted or unsubstituted C₂-C₅ aldehydes, substituted or unsubstituted C₂-C₅ amides, substituted or unsubstituted C₂-C₅ carboxylic acids, substituted or unsubstituted C₂-C₅ esters, substituted or unsubstituted C₅-C₈ carbocyclic compounds, substituted or unsubstituted C₅-C₈ aromatic compounds, substituted or unsubstituted C₅-C₈ heteroaromatic compounds, carbon monoxide, carbon dioxide and mixtures thereof.

In some embodiments, the substituted C₁-C₁₀ alkanes, substituted C₂-C₁₀ alkenes, substituted C₂-C₁₀ alkynes, substituted C₁-C₁₀ alcohols, substituted C₂-C₁₀ ketones, substituted C₂-C₁₀ aldehydes, substituted C₂-C₁₀ amides, substituted C₂-C₁₀ carboxylic acids, substituted C₂-C₁₀ esters, substituted C₅-C₁₀ carbocyclic compounds, substituted C₅-C₁₀ aromatic compounds, and/or substituted C₅-C₁₀ heteroaromatic compounds, are independently substituted with a group selected from the group consisting of amino, nitro, cyano, and halo.

In some embodiments, the carbon containing compound is selected from the group consisting of carbon dioxide, carbon monoxide, methane, ethane, heptane, glycerol, ethanol, acetone, butanol, toluene and mixtures thereof. In some embodiments, the carbon containing compound is selected from the group consisting of carbon monoxide, methane, ethane, heptane, glycerol, ethanol, acetone, butanol, toluene and mixtures thereof.

The carbon containing compound may be a mixture of one or more carbon containing compounds. In some embodiments, the carbon containing compound is a mixture of from 1 to 10 carbon containing compounds. For example, the carbon containing compound may be a mixture of from 1 to 8, 1 to 5, or 1 to 3 carbon containing compounds. For example, the carbon containing compound may be a mixture of 1, 2, 3, 4, 5, 6, 7, 8, 9, or 10 carbon containing compounds. When the carbon containing compound is a mixture of carbon containing compounds, each carbon containing compound of the mixture of carbon containing compounds may independently be as described herein.

In some embodiments, the carbon containing compound is not carbon dioxide.

In some embodiments, when the first fluid comprises a carbon containing compound which is carbon dioxide, the first fluid further comprises a carbon containing compound as described herein. In some embodiments, when the first fluid comprises a carbon containing compound which is carbon dioxide and does not comprise a hydrogen containing molecule that is not a hydrocarbon, the first fluid further comprises a carbon containing compound as described herein.

### Hydrogen Containing Molecule

In some embodiments, the hydrogen containing molecule that is not a hydrocarbon is selected from the group consisting of hydrogen, amines, and hydrides.

In some embodiments, the hydrogen containing molecule that is not a hydrocarbon is selected from the group consisting of hydrogen, ammonia, metal hydrides (optionally wherein the metal of the metal hydride is selected from the group consisting of As, Sb, and mixtures thereof.

The hydrogen containing molecule that is not a hydrocarbon may be a mixture of one or more hydrogen containing molecules that are not a hydrocarbon. In some embodiments, the hydrogen containing molecule that is not a hydrocarbon is a mixture of from 1 to 10 hydrogen containing molecules that are not a hydrocarbon. For example, the hydrogen containing molecule that is not a hydrocarbon may be a mixture of from 1 to 10, 1 to 5, or 1 to 3 hydrogen containing molecules that are not a hydrocarbon. For example, the hydrogen containing molecule that is not a hydrocarbon may be a mixture of 1, 2, 3, 4, 5, 6, 7, 8, 9, or 10 hydrogen containing molecules that are not a hydrocarbon. When the hydrogen containing molecule that is not a hydrocarbon is a mixture of hydrogen containing molecules that are not a hydrocarbon, each hydrogen containing molecule that is not a hydrocarbon of the mixture of hydrogen containing molecules that are not a hydrocarbon may independently be as described herein.

### Auxiliary Fluid

In some embodiments, the first fluid comprises an auxiliary fluid. The auxiliary fluid may be a mixture. The auxiliary fluid may comprise one or more carrier fluids and/or one or more auxiliary impurity. The auxiliary fluid may consist of one or more carrier fluid and/or one or more auxiliary impurities.

In some embodiments, the auxiliary fluid does not comprise oxygen gas (O₂) or nitrogen dioxide.

The carrier fluid may be selected from fluids that do not contain hydrogen and/or carbon. For example, the carrier fluid may be selected from the group consisting of noble gases (such as helium, neon, argon, krypton, xenon, and/or radon), nitrogen, or mixtures thereof.

The auxiliary impurity may be selected from impurities found in a fluid from an industrial process. In some embodiments, the auxiliary impurity is silane.

### Second Fluid

In all embodiments, the sum of the components in the second fluid does not exceed 100 vol %.

(i) when the First Fluid Comprises a Carbon Containing Compound, the Second Fluid Comprises Carbon Dioxide and at Least One Impurity.

In some embodiments, the second fluid comprises from about 0.1 vol % to about 99 vol % of carbon dioxide. In some embodiments, the second fluid comprises from about 0.1 vol % to about 99 vol %, about 95 vol %, about 90 vol %, about 80 vol %, about 70 vol %, about 60 vol %, about 50 vol %, about 40 vol %, about 30 vol %, about 20 vol %, about 10 vol %, or about 5 vol % of carbon dioxide.

In some embodiments, the second fluid comprises from about 0.1 vol %, about 1 vol %, about 2 vol %, about 5 vol %, about 10 vol %, about 20 vol %, about 30 vol %, about 40 vol %, about 50 vol %, about 60 vol %, about 70 vol %, about 80 vol %, or about 90 vol %, to about 99 vol % of carbon dioxide.

In some embodiments, the second fluid comprises water. In some embodiments, the second fluid comprises from about 0.1 vol % to about 99 vol % of water. In some embodiments, the second fluid comprises from about 0.1 vol % to about 99 vol %, about 95 vol %, about 90 vol %, about 80 vol %, about 70 vol %, about 60 vol %, about 50 vol %, about 40 vol %, about 30 vol %, about 20 vol %, about 10 vol %, about 5 vol %, or about 1 vol % of water.

In some embodiments, the second fluid comprises from about 0.1 vol %, about 1 vol %, about 2 vol %, about 5 vol %, about 10 vol %, about 20 vol %, about 30 vol %, about 40 vol %, about 50 vol %, about 60 vol %, about 70 vol %, about 80 vol %, or about 90 vol %, to about 99 vol % of water.

In some embodiments, when the first fluid comprises a carbon containing compound that does not comprise hydrogen (for example, carbon monoxide and/or carbon dioxide), the second fluid comprises substantially no water. For example, the second fluid comprises from about 0.001 vol % to about 0.1 vol % of water, from about 0.01 vol % to about 0.1 vol % of water, or from about 0.05 vol % to about 0.1 vol % of water.

In some embodiments, the second fluid comprises from about 0.1 vol % to about 99 vol % of the at least one impurity. In some embodiments, the second fluid comprises from about 0.1 vol % to about 99 vol %, about 95 vol %, about 90 vol %, about 80 vol %, about 70 vol %, about 60 vol %, about 50 vol %, about 40 vol %, about 30 vol %, about 20 vol %, about 10 vol %, or about 5 vol % of the at least one impurity.

In some embodiments, the second fluid comprises from about 0.1 vol %, about 1 vol %, about 2 vol %, about 5 vol %, about 10 vol %, about 20 vol %, about 30 vol %, about 40 vol %, about 50 vol %, about 60 vol %, about 70 vol %, about 80 vol %, or about 90 vol %, to about 99 vol % of the at least one impurity.

(ii) when the First Fluid Comprises a Hydrogen Containing Molecule that is not a Carbon Containing Compound, the Second Fluid Comprises Water, and at Least One Impurity.

In some embodiments, the second fluid comprises from about 0.1 vol % to about 99 vol % of water. In some embodiments, the second fluid comprises from about 0.1 vol % to about 99 vol %, about 95 vol %, about 90 vol %, about 80 vol %, about 70 vol %, about 60 vol %, about 50 vol %, about 40 vol %, about 30 vol %, about 20 vol %, about 10 vol %, or about 5 vol % of water.

In some embodiments, the second fluid comprises from about 0.1 vol %, about 1 vol %, about 2 vol %, about 5 vol %, about 10 vol %, about 20 vol %, about 30 vol %, about 40 vol %, about 50 vol %, about 60 vol %, about 70 vol %, about 80 vol %, or about 90 vol %, to about 99 vol % of water.

In some embodiments, the second fluid comprises from about 0.1 vol % to about 99 vol % of the at least one impurity. In some embodiments, the second fluid comprises from about 0.1 vol % to about 99 vol %, about 95 vol %, about 90 vol %, about 80 vol %, about 70 vol %, about 60 vol %, about 50 vol %, about 40 vol %, about 30 vol %, about 20 vol %, about 10 vol %, or about 5 vol % of the at least one impurity.

In some embodiments, the second fluid comprises from about 0.1 vol %, about 1 vol %, about 2 vol %, about 5 vol %, about 10 vol %, about 20 vol %, about 30 vol %, about 40 vol %, about 50 vol %, about 60 vol %, about 70 vol %, about 80 vol %, or about 90 vol %, to about 99 vol % of the at least one impurity.

(iii) when the First Fluid Comprises a Combination of a Carbon Containing Compound and a Hydrogen Containing Molecule that is not a Carbon Containing Compound, the Second Fluid Comprises Carbon Dioxide, Water, and at Least One Impurity.

In some embodiments, the second fluid comprises from about 0.1 vol % to about 99 vol % of carbon dioxide. In some embodiments, the second fluid comprises from about 0.1 vol % to about 99 vol %, about 95 vol %, about 90 vol %, about 80 vol %, about 70 vol %, about 60 vol %, about 50 vol %, about 40 vol %, about 30 vol %, about 20 vol %, about 10 vol %, or about 5 vol % of carbon dioxide.

In some embodiments, the second fluid comprises from about 0.1 vol %, about 1 vol %, about 2 vol %, about 5 vol %, about 10 vol %, about 20 vol %, about 30 vol %, about 40 vol %, about 50 vol %, about 60 vol %, about 70 vol %, about 80 vol %, or about 90 vol %, to about 99 vol % of carbon dioxide.

In some embodiments, the second fluid comprises from about 0.1 vol % to about 99 vol % of water. In some embodiments, the second fluid comprises from about 0.1 vol % to about 99 vol %, about 95 vol %, about 90 vol %, about 80 vol %, about 70 vol %, about 60 vol %, about 50 vol %, about 40 vol %, about 30 vol %, about 20 vol %, about 10 vol %, or about 5 vol % of water.

In some embodiments, the second fluid comprises from about 0.1 vol %, about 1 vol %, about 2 vol %, about 5 vol %, about 10 vol %, about 20 vol %, about 30 vol %, about 40 vol %, about 50 vol %, about 60 vol %, about 70 vol %, about 80 vol %, or about 90 vol %, to about 99 vol % of water.

In some embodiments, the second fluid comprises from about 0.1 vol % to about 99 vol % of the at least one impurity. In some embodiments, the second fluid comprises from about 0.1 vol % to about 99 vol %, about 95 vol %, about 90 vol %, about 80 vol %, about 70 vol %, about 60 vol %, about 50 vol %, about 40 vol %, about 30 vol %, about 20 vol %, about 10 vol %, or about 5 vol % of the at least one impurity.

In some embodiments, the second fluid comprises from about 0.1 vol %, about 1 vol %, about 2 vol %, about 5 vol %, about 10 vol %, about 20 vol %, about 30 vol %, about 40 vol %, about 50 vol %, about 60 vol %, about 70 vol %, about 80 vol %, or about 90 vol %, to about 99 vol % of the at least one impurity.

### Third Fluid

In all embodiments, the sum of the components in the third fluid does not exceed 100 vol %.

(i) when the First Fluid Comprises a Carbon Containing Compound, the Third Fluid Comprises Carbon Dioxide and Optionally at Least One Impurity; and the Concentration of Carbon Dioxide in the Third Fluid is Greater than the Concentration of Carbon Dioxide in the Second Fluid.

In some embodiments, the concentration of carbon dioxide in the third fluid is from about 1% to about 500% greater than the concentration of carbon dioxide in the second fluid. In some embodiments, the concentration of carbon dioxide in the third fluid is from about 1% to about 200% greater than the concentration of carbon dioxide in the second fluid. For example, the concentration of carbon dioxide in the third fluid is from about 50% to about 200% greater than the concentration of carbon dioxide in the second fluid.

For example, the concentration of carbon dioxide in the third fluid is about 1%, 2%, 5%, 10%, 20%, 25%, 50%, 75%, 100%, 150%, 200% or 500% greater than the concentration of carbon dioxide in the second fluid.

In some embodiments, the third fluid comprises from about 0.1 vol % to about 99 vol % of carbon dioxide. For example, the third fluid comprises from about 25 vol % to about 99 vol % of carbon dioxide. Preferably, the third fluid comprises from about 25 vol % to about 99 vol % of carbon dioxide, from about 33 vol % to about 99 vol % of carbon dioxide, or from about 50 vol % to about 99 vol % of carbon dioxide.

In some embodiments, the second fluid comprises water and the third fluid comprises water. In some embodiments, the concentration of water in the third fluid is from about 1% to about 2000% greater than the concentration of water in the second fluid. In some embodiments, the concentration of water in the third fluid is from about 1% to about 500% greater than the concentration of water in the second fluid. For example, the concentration of water in the third fluid is from about 50% to about 500% greater than the concentration of water in the second fluid. For example, the concentration of water in the third fluid is from about 50% to about 200% greater than the concentration of water in the second fluid.

For example, the concentration of water in the third fluid is about 1%, 2%, 5%, 10%, 20%, 25%, 50%, 75%, 100%, 150%, 200% or 500% greater than the concentration of water in the second fluid.

In some embodiments, the third fluid comprises from about 0.1 vol % to about 99 vol % of water. In some embodiments, the third fluid comprises from about 0.1 vol % to about 75 vol % of water. In some embodiments, the third fluid comprises from about 0.1 vol % to about 50 vol % of water. For example, the third fluid comprises from about 1 vol % to about 75 vol % of water, from about 10 vol % to about 75 vol % of water, from about 25 vol % to about 75 vol % of water, or from about 50 vol % to about 75 vol % of water.

In some embodiments, when the first fluid comprises a carbon containing compound that does not comprise hydrogen (for example, carbon monoxide and/or carbon dioxide), the third fluid comprises substantially no water. For example, the third fluid comprises from about 0.001 vol % to about 0.1 vol % of water, from about 0.01 vol % to about 0.1 vol % of water, or from about 0.05 vol % to about 0.1 vol % of water.

(ii) when the First Fluid Comprises a Hydrogen Containing Molecule that is not a Carbon Containing Compound, the Second Fluid Comprises Water, and at Least One Impurity; and the Concentration of Water in the Third Fluid is Greater than the Concentration of Water in the Second Fluid.

In some embodiments, the concentration of water in the third fluid is from about 1% to about 2000% greater than the concentration of water in the second fluid. In some embodiments, the concentration of water in the third fluid is from about 1% to about 500% greater than the concentration of water in the second fluid. For example, the concentration of water in the third fluid is from about 50% to about 500% greater than the concentration of water in the second fluid. For example, the concentration of water in the third fluid is from about 50% to about 200% greater than the concentration of water in the second fluid.

For example, the concentration of water in the third fluid is about 1%, 2%, 5%, 10%, 20%, 25%, 50%, 75%, 100%, 150%, 200% or 500% greater than the concentration of water in the second fluid.

In some embodiments, the third fluid comprises from about 0.1 vol % to about 99 vol % of water. For example, the third fluid comprises from about 25 vol % to about 99 vol % of water. Preferably, the third fluid comprises from about 25 vol % to about 99 vol % of water, from about 33 vol % to about 99 vol % of water, or from about 50 vol % to about 99 vol % of water.

(iii) when the First Fluid Comprises a Combination of a Carbon Containing Compound and a Hydrogen Containing Molecule that is not a Carbon Containing Compound, the Second Fluid Comprises Carbon Dioxide, Water, and at Least One Impurity; and the Concentration of Carbon Dioxide in the Third Fluid is Greater than the Concentration of Carbon Dioxide in the Second Fluid.

In some embodiments, the concentration of carbon dioxide in the third fluid is from about 1% to about 500% greater than the concentration of carbon dioxide in the second fluid. In some embodiments, the concentration of carbon dioxide in the third fluid is from about 1% to about 200% greater than the concentration of carbon dioxide in the second fluid. For example, the concentration of carbon dioxide in the third fluid is from about 50% to about 200% greater than the concentration of carbon dioxide in the second fluid. For example, the concentration of carbon dioxide in the third fluid is about 1%, 2%, 5%, 10%, 20%, 25%, 50%, 75%, 100%, 150%, 200% or 500% greater than the concentration of carbon dioxide in the second fluid.

In some embodiments, the third fluid comprises from about 0.1 vol % to about 99 vol % of carbon dioxide. For example, the third fluid comprises from about 50 vol % to about 99 vol % of carbon dioxide.

In some embodiments, the third fluid comprises from about 0.1 vol % to about 80 vol % of carbon dioxide. In some embodiments, the third fluid comprises from about 0.1 vol % to about 75 vol % of carbon dioxide. For example, the third fluid comprises from about 0.1 vol % to about 66 vol % of carbon dioxide. For example, the third fluid comprises from about 1 vol % to about 66 vol % of water, from about 10 vol % to about 66 vol % of water, from about 25 vol % to about 66 vol % of water, or from about 50 vol % to about 66 vol % of water.

In some embodiments, the concentration of water in the third fluid is from about 1% to about 2000% greater than the concentration of water in the second fluid. In some embodiments, the concentration of water in the third fluid is from about 1% to about 500% greater than the concentration of water in the second fluid. For example, the concentration of water in the third fluid is from about 50% to about 500% greater than the concentration of water in the second fluid. For example, the concentration of water in the third fluid is from about 50% to about 200% greater than the concentration of water in the second fluid.

For example, the concentration of water in the third fluid is about 1%, 2%, 5%, 10%, 20%, 25%, 50%, 75%, 100%, 150%, 200% or 500% greater than the concentration of water in the second fluid.

In some embodiments, the third fluid comprises from about 0.1 vol % to about 99 vol % of water. For example, the third fluid comprises from about 0.1 vol % to about 50 vol % of water. For example, the third fluid comprises from about 25 vol % to about 99 vol % of water. Preferably, the third fluid comprises from about 25 vol % to about 99 vol % of water, from about 33 vol % to about 99 vol % of water, or from about 50 vol % to about 99 vol % of water.

### Impurity

In some embodiments, the at least one impurity is selected from the group consisting of a carbon containing compound, a hydrogen containing molecule that is not a hydrocarbon, an auxiliary fluid and mixtures thereof. Each of the carbon containing compound, the hydrogen containing molecule that is not a hydrocarbon, and the auxiliary fluid may independently be as described herein.

For example, the at least one impurity may be a partially oxygenated counterpart of the carbon containing compound, the hydrogen containing compound that is not a hydrocarbon, the auxiliary fluid, or mixtures thereof.

In some embodiments, the at least one impurity is selected from the group consisting of hydrogen, carbon monoxide, methane, ethane, glycerol, ethanol, acetone, butanol, heptane, toluene and mixtures thereof.

In some embodiments, when the first fluid comprises a carbon containing compound, the at least one impurity is selected from the group consisting of carbon monoxide, hydrogen and the carbon containing compound. In some embodiments, when the first fluid comprises a carbon containing compound, the at least one impurity is selected from the group consisting of carbon monoxide, methane, ethane, glycerol, ethanol, acetone, butanol, heptane, toluene and mixtures thereof.

In some embodiments, when the first fluid comprises a hydrogen containing molecule that is not a hydrocarbon, the at least one impurity may be the hydrogen containing molecule that is not a hydrocarbon. In some embodiments, when the first fluid comprises a hydrogen containing molecule that is not a hydrocarbon, the at least one impurity may be hydrogen.

The at least one impurity of the third fluid may independently be as described herein in relation to the second fluid.

In some embodiments, the concentration of the at least one impurity in the third fluid is less than the concentration of the at least one impurity in the second fluid. Without wishing to be bound by theory, this is because at least a proportion of the at least one impurity in the second fluid has been converted to carbon dioxide and/or water. For example, the second vessel is configured to convert the at least one impurity into carbon dioxide and/or water.

In some embodiments, the concentration of the at least one impurity in the third fluid is from about 1% to about 500% less than the concentration of carbon dioxide in the second fluid. For example, the concentration of the at least one impurity in the third fluid is from about 1% to about 200% less than the concentration of carbon dioxide in the second fluid.

For example, the concentration of the at least one impurity in the third fluid is about 1%, 2%, 5%, 10%, 20%, 25%, 50%, 75%, 100%, 150%, 200% or 500% less than the concentration of the at least one impurity in the second fluid.

In some embodiments, the third fluid comprises from about 0.01 vol % to about 10 vol % of the at least one impurity. For example, the third fluid comprises from about 0.01 vol % to about 5 vol % of the at least one impurity. For example, the third fluid comprises from about 0.01 vol % to about 1 vol % of the at least one impurity.

### First Vessel

The first vessel is configured to convert a first fluid into a second fluid.

Without wishing to be bound by theory, the first vessel is configured to convert at least a proportion of the carbon containing compound and/or a hydrogen containing molecule that is not a hydrocarbon in the first fluid to carbon dioxide, water and/or at least one impurity. For example, the first vessel is configured to convert at least a proportion of the carbon containing compound into carbon dioxide and/or at least one impurity. For example, the first vessel is configured to convert at least a proportion of the hydrogen containing molecule that is not a hydrocarbon into water and/or at least one impurity.

The first vessel may be any vessel that is capable of converting at least a proportion of the carbon containing compound and/or a hydrogen containing molecule that is not a hydrocarbon in the first fluid to carbon dioxide, water and/or at least one impurity.

In particular, the first vessel may be a reaction vessel (such as a combustion vessel). The first vessel may be a fixed bed reactor (such as a packed bed reactor) or a fluidised bed reactor. The first vessel may comprise a first material which is configured to convert a first fluid into a second fluid.

The first vessel comprises an output which is coupled to the input of the second vessel. For example, the first vessel comprises an output which is directly coupled to the input of the second vessel.

The first vessel may also comprise an input configured to accept the first fluid. The first material may be positioned between the input and the output of the first vessel. As such, the first vessel is configured such that the first fluid can enter the first vessel and pass across and/or through the first material. The first fluid is thereby converted into the second fluid. The second fluid may exit the first vessel via the output.

In some embodiments, the first vessel has an internal volume of from about 1 L to about 100 L. In some embodiments, the first vessel has an internal volume of from about 1 L to about 75 L, from about 1 L to about 50 L, from about 1 L to about 25 L, or from about 1 L to about 10 L.

The first vessel may be configured to operate at a temperature of from about 300° C. to about 1000° C. and at a pressure of between 1 and 10 bar. For example, the first vessel may be configured to operate at a temperature of from about 300° C. to about 800° C. and at a pressure of between 1 and 10 bar. For example, the first vessel may be configured to operate at a temperature of from about 350° C. to about 750° C. and at a pressure of between 1 and 10 bar.

### First Material

The first vessel may comprise a first material which is configured to convert the first fluid into the second fluid. The first material may be any material known to the skilled person that fulfils the purpose of converting the first fluid into the second fluid.

The first material described herein (or any one or more of the components thereof) may be in solid form. For example, the first material may be a powder or any other solid form (such as a tablet or pellet). Preferably, the first material is in the form of a pellet.

For example, the first material may be selected from any of the materials described in Voitic et al., Recent advancements in chemical looping water splitting for the production of hydrogen, RSC Adv., 2016, 6, 98267-98296; and Zhao et al, Oxygen carriers for chemical-looping water splitting to hydrogen production: A critical review; Carbon Capture Science & Technology, Volume 1, December 2021, 100006; the contents of which are incorporated herein by reference.

In some embodiments, the first material is a metal oxide or a combination of metal oxides. In some embodiments, the metal of each of the metal oxides is independently selected from the group consisting of transition metals, lanthanides, and mixtures thereof. For example, the metal of each of the metal oxides is independently selected from the group consisting of Fe, Mn, Co, Pt, Sr, V, Nb, Mo, and W. For example, the metal of each of the metal oxides is independently selected from the group consisting of Fe, Mn, Co, Sr, V, Nb, Mo, and W. In some embodiments, each of the metal oxide(s) is selected from the group consisting of Fe₂O₃, Fe₃O₄, FeO, LaFeO₃, SrFeO₃ and mixtures thereof.

In some embodiments, the first material is a combination of a first metal oxide and a second metal oxide, wherein
the second metal oxide is a mixed ionic-electronic conductor,
the first metal oxide comprises a metal (M) and oxygen; and
the first metal oxide's change in standard Gibbs energy (in J/mol O₂) for the reaction:

$${M}_{x} {O}_{y} + {O}_{2} = {M}_{x} {O}_{y + 2}$$

wherein x is from 0.1 to 5, and y is from 0 to 5,
is bounded by:

$$25.7 T - 488470 < Δ {G}^{0} ( T ) < 178.9 T - 488470$$

for T being from 300K to 1000K.

The general Ellingham diagram shows the change in standard Gibbs energy for the metal oxide oxidation and reduction reaction:

$${M}_{x} {O}_{y} + {O}_{2} = {M}_{x} {O}_{y + 2} : Δ G = RT ln ( \frac{{P}_{O2}}{1 bar} ) \qquad ( 1 )$$

In some embodiments, the first metal oxide's change in standard Gibbs energy (in J/mol O₂) for the reaction:

$${M}_{x} {O}_{y} + {O}_{2} = {M}_{x} {O}_{y + 2}$$

is bounded by:

$$64. T - 488470 < Δ {G}^{0} ( T ) < 140.6 T - 488470$$

for T being from 300K to 1000K.

In some embodiments, the first metal oxide's change in standard Gibbs energy (in J/mol O₂) for the reaction:

$${M}_{x} {O}_{y} + {O}_{2} = {M}_{x} {O}_{y + 2}$$

is between the lower limit and upper limit for a given temperature as defined in any of tables 1 to 4.

TABLE 1

ΔG⁰(T) (J/mol O₂)

| T (K) | Lower Limit | Upper Limit |
|---|---|---|
| 300 | −479968 | −434023 |
| 400 | −478426 | −417166 |
| 500 | −476381 | −399806 |
| 600 | −473950 | −382060 |
| 700 | −471215 | −364011 |
| 800 | −468239 | −345719 |
| 900 | −465067 | −327233 |
| 1000 | −461738 | −308589 |

TABLE 2

ΔG⁰(T) (J/mol O₂)

| T (K) | Lower Limit | Upper Limit |
|---|---|---|
| 300 | −434800 | −480760 |
| 400 | −416910 | −478190 |
| 500 | −399020 | −475620 |
| 600 | −381130 | −473050 |
| 700 | −363240 | −470480 |
| 800 | −345350 | −467910 |
| 900 | −327460 | −465340 |
| 1000 | −309570 | −462770 |

TABLE 3

ΔG⁰(T) (J/mol O₂)

| T (K) | Lower Limit | Upper Limit |
|---|---|---|
| 300 | −468482 | −445510 |
| 400 | −463111 | −432481 |
| 500 | −457237 | −418950 |
| 600 | −450977 | −405032 |
| 700 | −444414 | −390812 |
| 800 | −437609 | −376349 |
| 900 | −430608 | −361691 |
| 1000 | −423451 | −346876 |

TABLE 4

ΔG⁰(T) (J/mol O₂)

| T (K) | Lower Limit | Upper Limit |
|---|---|---|
| 300 | −446290 | −469270 |
| 400 | −432230 | −462870 |
| 500 | −418170 | −456470 |
| 600 | −404110 | −450070 |
| 700 | −390050 | −443670 |
| 800 | −375990 | −437270 |
| 900 | −361930 | −430870 |
| 1000 | −347870 | −424470 |

Tables 1 to 4 are derived from data publicly available, for example at: https://cearun.grc.nasa.gov/ThermoBuild/.

The change in standard Gibbs energy can be calculated for a given metal oxide as described in equation 1 described herein.

The standard Gibbs energy for known metal oxides described herein are publicly available, for example at: https://cearun.gre.nasa.gov/ThermoBuild/.

If this is not available, the skilled person can simply retrieve or determine experimentally the pO₂ values for a given metal oxide reaction, and thus deduce the standard Gibbs energy.

In some embodiments, the metal of the first metal oxide is selected from the group consisting of transition metals, lanthanides, p-block metals, s-block metals and mixtures thereof. In some embodiments, the transition metal is selected from the group consisting of iron, manganese, cobalt, molybdenum, tungsten, and mixtures thereof. In some embodiments, the first metal oxide comprises iron. Preferably, the first metal oxide consists of iron and oxygen. For example, the first metal oxide is selected from the group consisting of Fe₂O₃, Fe₃O₄, FeO, and mixtures thereof. Preferably, the first metal oxide comprises or consists of FeO. Preferably, the first metal oxide comprises or consists of Fe₃O₄.

In some embodiments, the first metal oxide may be a reduced first metal oxide. For example, after the first metal oxide has been contacted with a first fluid as described herein.

### Second Metal Oxide:

In some embodiments, the second metal oxide is a mixed ionic-electronic conductor. In some embodiments, the second metal oxide is perovskite type metal oxide. That is, the second metal oxide is a perovskite type metal oxide at standard temperature and pressure (0° C. and 1 atmosphere of pressure). The second metal oxide may also be a perovskite type metal oxide at room temperature and pressure (about 25° C. and about 1 atmosphere of pressure). The second metal oxide may also be a perovskite type metal oxide at a temperature and pressure used in the processes described herein.

In some embodiments, the second metal oxide has the formula ABX_{3-δ}, wherein A is one or more metals; B is one or more metals; X is oxygen; and δ is from 0 to 0.5. δ represents the non-stoichiometry of the second metal oxide (perovskite type metal oxide).

In some embodiments, A is selected from the group consisting of transition metals, lanthanides, actinides, p-block metals, s-block metals and mixtures thereof; and/or B is selected from the group consisting of transition metals, lanthanides, actinides, p-block metals, s-block metals and mixtures thereof.

In some embodiments, A is selected from the group consisting of transition metals, lanthanides, actinides, p-block metals, s-block metals and mixtures thereof. In some embodiments, A is independently selected from the group consisting of La, Sr, Gd, Ca, Ce, K, Y, and mixtures thereof. Preferably, A is independently selected from the group consisting of La, Sr, Gd, Ca, Ce, and mixtures thereof. For example, A is independently selected from the group consisting of La, Sr, Gd, and mixtures thereof.

In some embodiments, A comprises Sr or La. In some embodiments, B consists of Sr or La. In some embodiments, A is Sr or La.

In some embodiments, A is A¹ₓA²₍₁₋ₓ), and wherein A¹ and A² are each independently the same as described for A. In such embodiments, A¹ and A² are independently the same or different, for example different. X may be any value from 0.01 to 0.99, such as 0.05 to 0.95. For example, x is 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, or 0.95. Preferably, x is 0.5, 0.6, 0.75, or 0.95.

For example, each A¹ and A² is independently selected from the group consisting of transition metals, lanthanides, actinides, p-block metals, s-block metals and mixtures thereof. In some embodiments, each A¹ and A² is independently selected from the group consisting of La, Sr, Gd, Ca, Ce, K, Y, and mixtures thereof. Preferably, each A¹ and A² is independently selected from the group consisting of La, Sr, Gd, Ca, Ce, and mixtures thereof. For example, each A¹ and A² is independently selected from the group consisting of La, Sr, Gd, and mixtures thereof.

In some embodiments, A¹ is Sr or La, and A² is Ce, Sr, La or Ca. For example, A¹ₓA²₍₁₋ₓ₎, is SrₓCe₍₁₋ₓ₎, SrₓLa₍₁₋ₓ₎, or SrₓCa₍₁₋ₓ₎. For example, A¹ₓA²₍₁₋ₓ₎, is LaₓCe₍₁₋ₓ₎, LaₓSr₍₁₋ₓ₎, or LaₓCa₍₁₋ₓ₎. For example, A¹ₓA²₍₁₋ₓ₎, is Sr_{0.95}Ce_{0.05}, Sr_{0.75}La_{0.25}, Sr_{0.5}La_{0.5}, or Sr_{0.6}Ca_{0.4}. For example, A¹ₓA²₍₁₋ₓ₎, is La_{0.95}Ce_{0.05}, La_{0.75}Sr_{0.25}, or La_{0.6}Ca_{0.4}.

For example, B is selected from the group consisting of transition metals, lanthanides, actinides, p-block metals, s-block metals and mixtures thereof. In some embodiments, B is independently selected from the group consisting of Fe, Mn, Cu, Ce, Co, Ti, Ni, and mixtures thereof. Preferably, B is independently selected from the group consisting of Fe, Mn, Cu, Ce, Co, Ti, Ni, and mixtures thereof. For example, A is independently selected from the group consisting of Fe, Mn, Cu, Ce, Ti, Ni, and mixtures thereof.

In some embodiments, B comprises Fe. In some embodiments, B consists of Fe. In some embodiments, B is Fe.

In some embodiments, B is B¹ₓB²₍₁₋ₓ₎, and wherein B¹ and B² are each independently the same as described for B. In such embodiments, B¹ and B² are independently the same or different, for example different. x may be any value from 0.01 to 0.99, such as 0.05 to 0.95. For example, x is 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, or 0.95. Preferably, x is 0.4, 0.5, or 0.25.

In some embodiments, B² may be B^{2A}_{y1}B^{2B}_{y2}, wherein y1+y2=(1−x). For example, when x=0.4, y1+y2=0.6. For example, when x=0.5, y1+y2=0.5. For example, y1 and y2 may each individually be 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, provided that y1+y2=(1−x). In some embodiments, each B^{2A} may as described for B² herein. In some embodiments, each B^{2B} may as described for B² herein.

For example, each B¹ and B² is selected from the group consisting of transition metals, lanthanides, actinides, p-block metals, s-block metals and mixtures thereof. In some embodiments, each B¹ and B² is independently selected from the group consisting of Fe, Mn, Cu, Ce, Co, Ti, Ni, and mixtures thereof. Preferably, each B¹ and B² is independently selected from the group consisting of Fe, Mn, Cu, Ce, Co, Ti, Ni, and mixtures thereof. For example, each B¹ and B² is independently selected from the group consisting of Fe, Mn, Cu, Ce, Ti, Ni, and mixtures thereof.

In some embodiments, B¹ is Fe and B² is Mn, Cu, Ce, Co, Ti, Ni, or mixtures thereof. For example, B¹ is Fe and B² is Mn, Cu, Ti, or Ni. For example, B¹ₓB²₍₁₋ₓ₎, is FeₓCu₍₁₋ₓ₎, FeₓMn₍₁₋ₓ₎, or Feₓ(NiTi)₍₁₋ₓ₎. For example, B¹ₓB²₍₁₋ₓ₎, is Fe_{0.95}Cu_{0.05}, Fe_{0.4}Mn_{0.6}, or Fe_{0.5}Ni_{0.25} Ti_{0.25}.

In some embodiments, the second metal oxide has the formula A¹ₓA²₍₁₋ₓ₎BX_{3-δ}. In some embodiments, the second metal oxide has the formula AB¹ₓB²₍₁₋ₓ₎ X_{3-δ}.

In some embodiments, A is Sr, B¹ is Fe and B² is Mn, Cu, Ce, Co, Ti, Ni, or mixtures thereof. For example, A is Sr, B¹ is Fe and B² is Mn, Cu, Ti, Ni, or mixtures thereof. For example, A is Sr, and B¹ₓB²₍₁₋ₓ₎, is FeₓCu₍₁₋ₓ₎, FeₓMn₍₁₋ₓ₎, or Feₓ (NiTi)₍₁₋ₓ₎. For example, B¹ₓB²₍₁₋ₓ₎, is Fe_{0.95}Cu_{0.05}, Fe_{0.4}Mn_{0.6}, or Fe_{0.5}Ni_{0.25}Ti_{0.25}.

In some embodiments, A is La, B¹ is Fe and B² is Mn, Cu, Ce, Co, Ti, Ni, or mixtures thereof. For example, A is La, B¹ is Fe and B² is Mn, Cu, Ti, Ni, or mixtures thereof. For example, A is La, and B¹ₓB²₍₁₋ₓ₎, is FeₓCu₍₁₋ₓ₎, FeₓMn₍₁₋ₓ₎, or Feₓ (NiTi)₍₁₋ₓ₎. For example, B¹ₓB²₍₁₋ₓ₎, is Fe_{0.95}Cu_{0.05}, Fe_{0.4}Mn_{0.6}, or Fe_{0.5}Ni_{0.25}Ti_{0.25}.

In some embodiments, A¹ is Sr or La, and A² is Ce, Sr, La or Ca; and B is Fe. For example, A¹ₓA²₍₁₋ₓ₎, is SrₓCe₍₁₋ₓ₎, SrₓLa₍₁₋ₓ₎, or SrₓCa₍₁₋ₓ₎; and B is Fe. For example, A¹ₓA²₍₁₋ₓ₎, is LaₓCe₍₁₋ₓ₎, LaₓSr₍₁₋ₓ₎, or LaₓCa₍₁₋ₓ₎; and B is Fe. For example, A¹ₓA²₍₁₋ₓ₎, is Sr_{0.95}Ce_{0.05}, Sr_{0.75} La_{0.25}, Sr_{0.5}La_{0.5}, or Sr_{0.6}Ca_{0.4}; and B is Fe. For example, A¹ₓA²₍₁₋ₓ₎, is La_{0.95}Ce_{0.05}, La_{0.75}Sr_{0.25}, or La_{0.6}Ca_{0.4}; and B is Fe.

In some embodiments, A is A¹ₓA²₍₁₋ₓ₎ and B is B¹ₓB²₍₁₋ₓ₎. In some embodiments, A¹ is Sr or La, and A² is Ce, Sr, La or Ca; and B¹ is Fe and B² is Mn, Cu, Ce, Co, Ti, Ni, or mixtures thereof.

For example, A¹ₓA²₍₁₋ₓ₎, is SrₓCe₍₁₋ₓ₎, SrₓLa₍₁₋ₓ₎, or SrₓCa₍₁₋ₓ₎; and B¹ₓB²₍₁₋ₓ₎, is FeₓCu₍₁₋ₓ₎, FeₓMn₍₁₋ₓ₎, or Feₓ (NiTi)₍₁₋ₓ₎. For example, A¹ₓA²₍₁₋ₓ₎, is LaₓCe₍₁₋ₓ₎, LaₓSr₍₁₋ₓ₎, or LaₓCa₍₁₋ₓ₎; and B¹ₓB²₍₁₋ₓ₎, is FeₓCu₍₁₋ₓ₎, FeₓMn₍₁₋ₓ₎, or Feₓ (NiTi)₍₁₋ₓ₎.

For example, A¹ₓA²₍₁₋ₓ₎, is Sr_{0.95}Ce_{0.05}, Sr_{0.75} La_{0.25}, Sr_{0.5}La_{0.5}, or Sr_{0.6} Ca_{0.4}; and B¹ₓB²₍₁₋ₓ₎, is Fe_{0.95}Cu_{0.05}, Fe_{0.4}Mn_{0.6}, or Fe_{0.5}Ni_{0.25}Ti_{0.25}. For example, A¹ₓA²₍₁₋ₓ₎, is La_{0.95}Ce_{0.05}, La_{0.75}Sr_{0.25}, or La_{0.6}Ca_{0.4}; and B¹ₓB²₍₁₋ₓ₎, is Fe_{0.95}Cu_{0.05}, Fe_{0.4}Mn_{0.6}, or Fe_{0.5}Ni_{0.25}Ti_{0.25}.

In some embodiments, the second metal oxide has the formula SrFeO_{3-δ}, LaFeO_{3-δ}, SrₓLa₍₁₋ₓ₎ FeO_{3-δ}, La_{0.75}Sr_{0.25}FeO_{3-δ}, SrFe_{0.95}Cu_{0.05}O_{3-δ}, Sr_{0.95}Ce_{0.05}FeO_{3-δ}, La_{0.6}Ca_{0.4}Fe_{0.4}Mn_{0.6}O_{3-δ}, or Sr_{0.5}La_{0.5}Fe_{0.5}Ni_{0.25}Ti_{0.25}O_{3-δ}. X may be any value from 0.01 to 0.99, such as 0.05 to 0.95. For example, x is 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, or 0.95. Preferably, x is 0.25, 0.4, 0.5, 0.6, 0.75, or 0.95.

In some embodiments, the second metal oxide is a mixed ionic-electronic conductor such as Gd_{0.3}Ce_{0.7}O_{2-δ} or Cu_{0.25}Co_{0.25}Fe_{2.5}O_{3-δ}.

Preferably, the first metal oxide is selected from the group consisting of Fe₂O₃, Fe₃O₄, FeO, and mixtures thereof. More preferably, the first metal oxide comprises or consists of Fe₃O₄. More preferably, the first metal oxide comprises or consists of FeO. In such embodiments, the second metal oxide has the formula SrFeO_{3-δ}, LaFeO_{3-δ}, SrₓLa₍₁₋ₓ₎FeO_{3-δ}, La_{0.75}Sr_{0.25}FeO_{3-δ}, SrFe_{0.95}Cu_{0.05}O_{3-δ}, Sr_{0.95}Ce_{0.05}FeO_{3-δ}, La_{0.6}Ca_{0.4}Fe_{0.4}Mn_{0.6}O_{3-δ}, or Sr_{0.5}La_{0.5}Fe_{0.5}Ni_{0.25}Ti_{0.25}O_{3-δ}. X may be any value from 0.01 to 0.99, such as 0.05 to 0.95. For example, x is 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, or 0.95. Preferably, x is 0.25, 0.4, 0.5, 0.6, 0.75, or 0.95.

In some embodiments, the combination comprises from about 5 wt. % to about 95 wt. % of the first metal oxide; and/or from about 5 wt. % to about 95 wt. % of the second metal oxide. The total composition of the combination does not exceed 100 wt. %.

Preferably, the combination comprises a (wt. % or molar, preferably molar) ratio of second metal oxide to first metal oxide of from about 1:0.9 to about 1:90. For example, the ratio of second metal oxide to first metal oxide is from about 1:4.5 to about 1:45. Preferably, the ratio of second metal oxide to first metal oxide is about 1:5, about 1:6, about 1:7, about 1:8, about 1:9, about 1:10, about 1:11, about 1:12, about 1:13, about 1:14 or about 1:15. Preferably, the ratio of second metal oxide to first metal oxide is about 1:7, about 1:8, about 1:9, about 1:10, about 1:11, or about 1:12.

In some embodiments, the combination comprises a (wt. % or molar, preferably molar) ratio of first metal oxide to second metal oxide of from about 1:0.9 to about 1:90. For example, the ratio of first metal oxide to second metal oxide is from about 1:4.5 to about 1:45. Preferably, the ratio of first metal oxide to second metal oxide is about 1:5, about 1:6, about 1:7, about 1:8, about 1:9, about 1:10, about 1:11, about 1:12, about 1:13, about 1:14 or about 1:15. Preferably, the ratio of first metal oxide to second metal oxide is about 1:7, about 1:8, about 1:9, about 1:10, about 1:11, or about 1:12.

In some embodiments, the combination comprises a third component which comprises at least one promoter. In some embodiments, the third component is a compound. For example, the third component is a metal oxide or mixture of metal oxides. For example, the third component is a metal. The term “third” means that the third component is in addition to the “first” metal oxide and “second” metal oxide.

The third component may be on the surface of the first metal oxide and/or the second metal oxide. The third component may be impregnated within the first metal oxide and/or the second metal oxide.

In some embodiments, the at least one promoter is selected from the group consisting of alkali metals, alkali earth metals, and mixtures thereof. In some embodiments, the promoter is an ion.

In some embodiments, the at least one promoter is selected from the group consisting of alkali metals, alkali earth metals, and mixtures thereof. In some embodiments, the third component is a metal oxide or mixture of metal oxides, wherein each metal of each metal oxide is independently selected from the group consisting of alkali metals, alkali earth metals, and mixtures thereof.

In some embodiments, the at least one promoter is selected from the group consisting of K, Na, Ag, Cs, Rb, Li, and mixtures thereof. Preferably, the at least one promoter is selected from the group of K, Na, Ag, and Cs. In some embodiments, the third component is a metal oxide or mixture of metal oxides, wherein each metal of each metal oxide is independently selected from the group consisting of K, Na, Ag, Cs, Rb, Li and mixtures thereof. Preferably, each metal of each metal oxide is independently selected from the group consisting of K, Na, Ag, and Cs.

In some embodiments, the third component is a metal oxide or mixture of metal oxides, wherein each metal oxide is independently selected from the group consisting of K₂O, Na₂O, Cs₂O, Rb₂O, Ag₂O, and Li₂O. Preferably, the third component is a metal oxide or mixture of metal oxides, wherein each metal oxide is independently selected from the group consisting of K₂O, Na₂O, Cs₂O, and Ag₂O.

In some embodiments, the combination comprises a catalytic amount of the third component. In some embodiments, the combination comprises a non-stoichiometric amount of the third component. For example, the combination comprises from about 0.1 wt. % to about 20 wt. % of the third component. Preferably, the combination comprises from about 1 wt. % to about 20 wt. % of the third component, such as from about 1 wt. % to about 15 wt. % of the third component or from about 5 wt. % to about 15 wt. % of the third component.

In some embodiments, the combination comprises about 1 wt %, about 5 wt. % about 10 wt % or about 15 wt. % of the third component.

Preferably, the first metal oxide is selected from the group consisting of Fe₂O₃, Fe₃O₄, FeO, and mixtures thereof. More preferably, the first metal oxide comprises or consists of FeO. In such embodiments, the second metal oxide has the formula SrFeO_{3-δ}, LaFeO_{3-δ}, SrₓLa₍₁₋ₓ₎FeO_{3-δ}, La_{0.75}Sr_{0.25}FeO_{3-δ}, SrFe_{0.95}Cu_{0.05}O_{3-δ}, Sr_{0.95}Ce_{0.05}FeO_{3-δ}, La_{0.6}Ca_{0.4}Fe_{0.4}Mn_{0.6}O_{3-δ}, or Sr_{0.5}La_{0.5}Fe_{0.5}Ni_{0.25}Ti_{0.25}O_{3-δ}. In such embodiments, the third component is a metal oxide or mixture of metal oxides, wherein each metal oxide is independently selected from the group consisting of K₂O, Na₂O, Cs₂O, Rb₂O, and Ag₂O. X may be any value from 0.01 to 0.99, such as 0.05 to 0.95. For example, x is 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, or 0.95. Preferably, x is 0.25, 0.4, 0.5, 0.6, 0.75, or 0.95.

In some embodiments, the first metal oxide is Fe₂O₃, Fe₃O₄, or FeO, the second metal oxide has the formula SrFeO_{3-δ} or LaFeO_{3-δ}, and the third component is a metal oxide wherein each metal oxide is independently selected from the group consisting of K₂O, Na₂O, Cs₂O, Rb₂O, and Ag₂O.

Preferably, the first metal oxide is Fe₂O₃, Fe₃O₄, or FeO, the second metal oxide has the formula SrₓLa₍₁₋ₓ₎FeO_{3-δ}, SrFeO_{3-δ} or LaFeO_{3-δ}, and the third component is a metal oxide or combination of metal oxides wherein each metal of each (third component) metal oxide is independently selected from the group consisting of K, Na, Ag, Cs, Rb, Li and mixtures thereof. Preferably, each metal of each (third component) metal oxide is independently selected from the group consisting of K, Na, Rb, Ag, and Cs. X may be any value from 0.01 to 0.99, such as 0.05 to 0.95. For example, x is 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, or 0.95. Preferably, x is 0.25, 0.4, 0.5, 0.6, 0.75, or 0.95.

More preferably, the first metal oxide is Fe₂O₃, Fe₃O₄, or FeO, the second metal oxide has the formula SrₓLa₍₁₋ₓ₎FeO_{3-δ}, SrFeO_{3-δ} or LaFeO_{3-δ}, and the third component is a metal oxide or combination of metal oxides wherein each (third component) metal oxide is independently selected from the group consisting of K₂O, Na₂O, Cs₂O, Rb₂O, and Ag₂O. X may be any value from 0.01 to 0.99, such as 0.05 to 0.95. For example, x is 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, or 0.95. Preferably, x is 0.25, 0.4, 0.5, 0.6, 0.75, or 0.95.

For example, the first metal oxide is Fe₂O₃, Fe₃O₄, or FeO, the second metal oxide has the formula SrₓLa₍₁₋ₓ₎FeO_{3-δ}, SrFeO_{3-δ} or LaFeO_{3-δ}, and the third component is a metal oxide or combination of metal oxides wherein each (third component) metal oxide is independently selected from the group consisting of K₂O, Na₂O, Cs₂O, Rb₂O, and Ag₂O; and wherein the combination comprises from about 0.1 wt. % to about 20 wt. % of the third component. Preferably, the combination comprises from about 1 wt. % to about 20 wt. % of the third component, such as from about 1 wt. % to about 15 wt. % of the third component or from about 5 wt. % to about 15 wt. % of the third component. X may be any value from 0.01 to 0.99, such as 0.05 to 0.95. For example, x is 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, or 0.95. Preferably, x is 0.25, 0.4, 0.5, 0.6, 0.75, or 0.95.

For example, the first metal oxide is Fe₂O₃, Fe₃O₄, or FeO, the second metal oxide has the formula SrₓLa₍₁₋ₓ₎FeO_{3-δ}, SrFeO_{3-δ} or LaFeO₃₋₈, and the third component is a metal oxide or combination of metal oxides wherein each (third component) metal oxide is independently selected from the group consisting of K₂O, Na₂O, Cs₂O, Rb₂O, and Ag₂O; wherein the combination comprises a ratio of second metal oxide to first metal oxide of from about 1:0.9 to about 1:90; and wherein the combination comprises from about 0.1 wt. % to about 20 wt. % of the third component. Preferably, the combination comprises from about 1 wt. % to about 20 wt. % of the third component, such as from about 1 wt. % to about 15 wt. % of the third component or from about 5 wt. % to about 15 wt. % of the third component. For example, the ratio of second metal oxide to first metal oxide is from about 1:4.5 to about 1:45. Preferably, the ratio of second metal oxide to first metal oxide is about 1:5, about 1:6, about 1:7, about 1:8, about 1:9, about 1:10, about 1:11, about 1:12, about 1:13, about 1:14 or about 1:15. Preferably, the ratio of second metal oxide to first metal oxide is about 1:7, about 1:8, about 1:9, about 1:10, about 1:11, or about 1:12. X may be any value from 0.01 to 0.99, such as 0.05 to 0.95. For example, x is 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, or 0.95. Preferably, x is 0.25, 0.4, 0.5, 0.6, 0.75, or 0.95.

For example, the first metal oxide is Fe₂O₃, Fe₃O₄, or FeO, the second metal oxide has the formula SrₓLa₍₁₋ₓ₎FeO_{3-δ}, SrFeO_{3-δ} or LaFeO_{3-δ}, and the third component is a metal oxide or combination of metal oxides wherein each (third component) metal oxide is independently selected from the group consisting of K₂O, Na₂O, Cs₂O, Rb₂O, and Ag₂O; wherein the combination comprises from about 5 wt. % to about 95 wt. % of the first metal oxide; and/or from about 5 wt. % to about 95 wt. % of the second metal oxide; and wherein the combination comprises from about 0.1 wt. % to about 20 wt. % of the third component. The total composition of the combination does not exceed 100 wt. %. Preferably, the combination comprises from about 1 wt. % to about 20 wt. % of the third component, such as from about 1 wt. % to about 15 wt. % of the third component or from about 5 wt. % to about 15 wt. % of the third component. X may be any value from 0.01 to 0.99, such as 0.05 to 0.95. For example, x is 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, or 0.95. Preferably, x is 0.25, 0.4, 0.5, 0.6, 0.75, or 0.95.

### Second Vessel

The second vessel is configured to convert the second fluid into the third fluid.

Without wishing to be bound by theory, the second vessel is configured to convert at least a proportion of the at least one impurity in the second fluid to carbon dioxide and/or water. For example, the second vessel is configured to convert at least a proportion of the at least one impurity compound into carbon dioxide. For example, the second vessel is configured to convert at least a proportion of the at least one impurity compound into water.

The second vessel may be any vessel that is capable of converting at least a proportion of the at least one impurity in the second fluid to carbon dioxide and/or water.

In particular, the second vessel may be a reaction vessel (such as a combustion vessel). The second vessel may be a fixed bed reactor (such as a packed bed reactor) or a fluidised bed reactor. Preferably, the second vessel is a chemical looping combustion vessel (for example, a fluidised bed reactor comprising a material configured to allow a chemical looping combustion reaction).

The second vessel may comprise a second material which is configured to convert the second fluid into the third fluid.

The second vessel comprises an input which is coupled to the output of the first vessel. For example, the first vessel comprises an output which is directly coupled to the input of the second vessel.

The input of the second vessel may be configured to accept the second fluid. The second vessel may also comprise an output. The second material is positioned between the input and the output of the second vessel. As such, the second vessel is configured such that the second fluid can enter the second vessel and pass across and/or through the second material. The second fluid is thereby converted into the third fluid. The third fluid may exit the second vessel via the output.

In some embodiments, the second vessel has an internal volume of from about 1 L to about 100 L. In some embodiments, the second vessel has an internal volume of from about 1 L to about 75 L, from about 1 L to about 50 L, from about 1 L to about 25 L, from about 1 L to about 10 L, or from about 1 L to about 5 L.

The second vessel may be configured to operate at a temperature of from about 300° C. to about 1000° C. and at a pressure of between 1 and 10 bar. For example, the second vessel may be configured to operate at a temperature of from about 300° C. to about 800° C. and at a pressure of between 1 and 10 bar. For example, the second vessel may be configured to operate at a temperature of from about 350° C. to about 750° C. and at a pressure of between 1 and 10 bar.

In preferred embodiments, the first vessel is a fixed bed reactor (such as a packed bed reactor) and the second vessel is a reaction vessel (such as a combustion vessel). The second vessel may be a fixed bed reactor (such as a packed bed reactor) or a fluidised bed reactor. Preferably, the second vessel is a chemical looping combustion vessel (for example, a fluidised bed reactor comprising a material configured to allow a chemical looping combustion reaction).

### Second Material

The second vessel may comprise a second material which is configured to convert the second fluid into the third fluid. The second material may be any material known to the skilled person that fulfils the purpose of converting a second fluid into a third fluid.

For example, the second material may be selected from any of the materials described in Jahromi et al, A review of chemical looping combustion technology: Fundamentals, and development of natural, industrial waste, and synthetic oxygen carriers, Fuel, Volume 341, 1 Jun. 2023, 127626; the contents of which are incorporated herein by reference.

In some embodiments, the second material may be as described herein in relation to the first material. In some embodiments, the second material is the same as the first material as described herein.

For example, the second material is a metal oxide or a combination of metal oxides. In some embodiments, the metal of each of the metal oxides is independently selected from the group consisting of transition metals, lanthanides, and mixtures thereof. For example, the metal of each of the metal oxides is independently selected from the group consisting of Fe, Cu, Mn, Co, Pt, Sr, V, Nb, Mo, and W. For example, the metal of each of the metal oxides is independently selected from the group consisting of Fe, Cu, Mn, Co, Sr, V, Nb, Mo, and W. In some embodiments, each of the metal oxide(s) is selected from the group consisting of Fe₂O₃, Fe₃O₄, FeO, LaFeO₃, SrFeO₃, CuO, and mixtures thereof.

The second material described herein (or any one or more of the components thereof) may be in solid form. For example, the second material may be a powder or any other solid form (such as a tablet or pellet). Preferably, the second material is in the form of a pellet.

### Third Vessel

In some embodiments, the system comprises a third vessel. The third vessel may be substantially the same as the first vessel as described herein.

In some embodiments, the third vessel is configured to convert a first fluid as described herein into a second fluid as described herein. When the first vessel and the third vessel are both configured to convert a first fluid as described herein into a second fluid as described herein, the first fluid of the first vessel and the first fluid of the third vessel may be the same or different.

In some embodiments, the third vessel comprises a first material as described herein. When the first vessel and the third vessel both comprise a first material as described herein, the first material of the first vessel and the first material of the third vessel may be the same or different.

In some embodiments, the third vessel has an internal volume of from about 1 L to about 100 L. In some embodiments, the third vessel has an internal volume of from about 1 L to about 75 L, from about 1 L to about 50 L, from about 1 L to about 25 L, from about 1 L to about 10 L, or from about 1 L to about 5 L.

The third vessel may comprise an output which is coupled to an input of the second vessel. The third vessel may be configured to provide a second fluid to the second vessel. For example, the third vessel may be configured to provide a second fluid to the second vessel whilst the first vessel provides a second fluid to the second vessel. Alternatively or additionally, the third vessel may be configured to provide a second fluid to the second vessel before and/or after the first vessel provides a second fluid to the second vessel.

By using a third vessel as described herein, it is possible to achieve continuous operation of the system because as the first vessel is taken offline or being taken offline (i.e. when the amount of first fluid being converted to second fluid in the first vessel is reducing/stopped), the third vessel can provide a second fluid to the second vessel. As such, continuous operation of the second vessel can be achieved.

### Fourth Vessel

In some embodiments, the system comprises a fourth vessel. The fourth vessel may be substantially the same as the second vessel as described herein.

In some embodiments, the fourth vessel is configured to convert a second fluid as described herein into a third fluid as described herein. When the second vessel and the fourth vessel are both configured to convert a second fluid as described herein into a third fluid as described herein, the second fluid of the second vessel and the second fluid of the fourth vessel may be the same or different. Similarly, the third fluid of the second vessel and the third fluid of the fourth vessel may be the same or different.

In some embodiments, the fourth vessel comprises a second material as described herein. When the second vessel and the fourth vessel both comprise a second material as described herein, the second material of the second vessel and the second material of the fourth vessel may be the same or different.

In some embodiments, the fourth vessel has an internal volume of from about 1 L to about 100 L. In some embodiments, the fourth vessel has an internal volume of from about 1 L to about 75 L, from about 1 L to about 50 L, from about 1 L to about 25 L, from about 1 L to about 10 L, or from about 1 L to about 5 L.

The fourth vessel may comprise an input which is coupled to an output of the first vessel and/or third vessel. The fourth vessel may be configured to receive a second fluid from the first vessel and/or third vessel (alternatively or sequentially).

By using a fourth vessel as described herein, it is possible to achieve continuous operation of the system because as the second vessel is taken offline or being taken offline (i.e. when the amount of second fluid being converted to third fluid in the second vessel is reducing/stopped), the fourth vessel can convert the second fluid from the first and/or third vessel into the third fluid. As such, continuous operation of the system vessel can be achieved.

### Further Components/Relationships

In some embodiments, the system comprises one or more flow regulators. For example, the system may comprise a flow regulator between an output of the first/third vessel and an input of the second/fourth vessel. Each of the one or more first flow regulators may comprise a valve and/or a pump (for example, a variable frequency drive pump).

In some embodiments, the system comprises one or more storage vessels. For example, the system may comprise a storage vessel between an output of the first/third vessel and an input of the second/fourth vessel. Each of the one or more storage vessels may have an internal volume of from about 1 L to about 100 L. In such embodiments, it is possible to produce a volume of second fluid and store it for a period of time before providing the second fluid to the second/fourth vessel. This is particularly useful when the first fluid comprises a low concentration of a carbon containing compound and/or a hydrogen containing molecule that is not a hydrocarbon.

In some embodiments, the first vessel and second vessel are in close proximity. For example, the first vessel and the second vessel are within about 10 metres, 5 metres or 1 meter of each other. In some embodiments, the distance the second fluid must travel between the first vessel and the second vessel is less than about 10 metres, about 5 metres, or about 1 meter.

In some embodiments, the third vessel and second vessel are in close proximity. For example, the first vessel and the second vessel are within about 10 metres, about 5 metres, or about 1 meter of each other. In some embodiments, the distance the second fluid must travel between the third vessel and the second vessel is less than about 10 metres, about 5 metres, or about 1 meter.

In some embodiments, the third vessel and fourth vessel are in close proximity. For example, the first vessel and the second vessel are within about 10 metres, about 5 metres, or about 1 meter of each other. In some embodiments, the distance the second fluid must travel between the third vessel and the fourth vessel is less than about about 10 metres, about 5 metres, or about 1 meter.

In some embodiments, the system comprises one or more further vessels. In some embodiments, the system may comprise one or more further vessels configured to decrease the concentration of water in the third fluid (for example a dehumidifier and/or a vessel comprising a molecular sieve). For example, the system may comprise one or more further vessels configured to reduce the concentration of water in the third fluid to less than 1 vol % For example, the further vessel may comprise an input which is coupled to the output of the second vessel.

In some embodiments, the system may comprise one or more further vessels configured to decrease the concentration of the auxiliary fluid in the second or third fluid. For example the system may comprise a molecular trap/sieve configured to achieve this purpose.

### Hydrogen Production

In some embodiments, the first vessel is in a first state or in a second state. When the first vessel is in the first state, the first vessel is configured to convert a first fluid into a second fluid, as described herein. When the first vessel is in the second state, the first vessel is configured to convert a fourth fluid into a fifth fluid, as described herein.

In some embodiments, the first vessel is configured to operate in a first state or in a second state. When the first vessel is configured to operate in the first state, the first vessel is configured to convert a first fluid into a second fluid, as described herein. When the first vessel is configured to operate in the second state, the first vessel is configured to convert a fourth fluid into a fifth fluid, as described herein.

In some embodiments, the first material is in a first state or in a second state. When the first material is in the first state, the first material is configured to convert a first fluid into a second fluid, as described herein. When the first material is in the second state, the first material is configured to convert a fourth fluid into a fifth fluid, as described herein.

In some embodiments, the first material is configured to operate in a first state or in a second state. When the first material is configured to operate in the first state, the first material is configured to convert a first fluid into a second fluid, as described herein. When the first material is configured to operate in the second state, the first material is configured to convert a fourth fluid into a fifth fluid, as described herein.

In some embodiments, contacting the first fluid with the first material results in the first material being (at least partially) reduced to a reduced first material (for example, the first material is in a second state as described herein).

### Fourth Fluid

The fourth fluid comprises water. In some embodiments, the water is deionised water. In some embodiments, the water is distilled water.

In some embodiments, the fourth fluid comprises an auxiliary fluid as described herein. In some embodiments, the fourth fluid is the third fluid from (ii) described herein. That is, the third fluid from (ii) may be used as the fourth fluid. In some embodiments, the fourth fluid does not comprise a carbon containing molecule or hydrogen containing molecule that is not a hydrocarbon as described herein.

In all embodiments, the sum of the components in the fourth fluid does not exceed 100 vol %.

In some embodiments, the fourth fluid comprises from about 1 vol % to about 100 vol % of water. For example, the fourth fluid comprises from about 2 vol % to about 100 vol % of water.

In some embodiments, the fourth fluid comprises from about 1 vol % to about 100 vol %, about 99 vol %, about 95 vol %, about 90 vol %, about 80 vol %, about 70 vol %, about 60 vol %, about 50 vol %, about 40 vol %, about 30 vol %, about 20 vol %, about 10 vol %, or about 5 vol % of water.

In some embodiments, the fourth fluid comprises from about 1 vol %, about 2 vol %, about 5 vol %, about 10 vol %, about 20 vol %, about 30 vol %, about 40 vol %, about 50 vol %, about 60 vol %, about 70 vol %, about 80 vol %, or about 90 vol %, to about 100 vol % of water.

### Fifth Fluid

The fifth fluid comprises hydrogen. In some embodiments, the fifth fluid comprises hydrogen and water. In some embodiments, the fifth fluid comprises an auxiliary fluid as described herein.

In all embodiments, the sum of the components in the fifth fluid does not exceed 100 vol %.

In some embodiments, the fifth fluid comprises from about 1 vol % to about 100 vol % of hydrogen.

In some embodiments, the fifth fluid comprises from about 1 vol % to about 100 vol %, about 99 vol %, about 95 vol %, about 90 vol %, about 80 vol %, about 70 vol %, about 60 vol %, about 50 vol %, about 40 vol %, about 30 vol %, about 20 vol %, about 10 vol %, or about 5 vol % of hydrogen.

In some embodiments, the fifth fluid comprises from about 1 vol %, about 2 vol %, about 5 vol %, about 10 vol %, about 20 vol %, about 30 vol %, about 40 vol %, about 50 vol %, about 60 vol %, about 70 vol %, about 80 vol %, or about 90 vol %, to about 100 vol % of hydrogen.

In some embodiments, the fifth fluid comprises from about 1 vol % to about 60 vol % of hydrogen and from about 1 vol % to about 40 vol % of water.

In some embodiments, the system may comprise one or more further vessels configured to decrease the concentration of water in the fifth fluid (for example a dehumidifier and/or a vessel comprising a molecular sieve). For example, the system may comprise one or more further vessels configured to reduce the concentration of water in the fifth vessel to less than 1 vol %

### Vessel

In a second aspect, the invention relates to a vessel comprising:
an input,
an output,
a first material, and
a second material;
   wherein:
   the first material is positioned between the input and the output,
   the second material is positioned between the input and the output,
   the first material is configured to convert a first fluid into a second fluid,
   the second material is configured to convert the second fluid into a third fluid, and
   the first fluid comprises:
a carbon containing compound,
a hydrogen containing molecule that is not a hydrocarbon, or
a combination of a carbon containing compound and a hydrogen containing molecule that is not a hydrocarbon;
(i) when the first fluid comprises a carbon containing compound:
   the second fluid comprises carbon dioxide and at least one impurity;
   the third fluid comprises carbon dioxide and optionally at least one impurity; and
   the concentration of carbon dioxide in the third fluid is greater than the concentration of carbon dioxide in the second fluid;
(ii) when the first fluid comprises a hydrogen containing molecule that is not a carbon containing compound:
   the second fluid comprises water, and at least one impurity;
   the third fluid comprises water and at least one impurity; and the concentration of water in the third fluid is greater than the concentration of water in the second fluid;
(iii) when the first fluid comprises a combination of a carbon containing compound and a hydrogen containing molecule that is not a carbon containing compound:
   the second fluid comprises carbon dioxide, water, and at least one impurity;
   the third fluid comprises carbon dioxide, water and at least one impurity; and
   the concentration of carbon dioxide in the third fluid is greater than the concentration of carbon dioxide in the second fluid.

The vessel of the second aspect may independently be the same as described herein in relation to the first vessel of the first aspect.

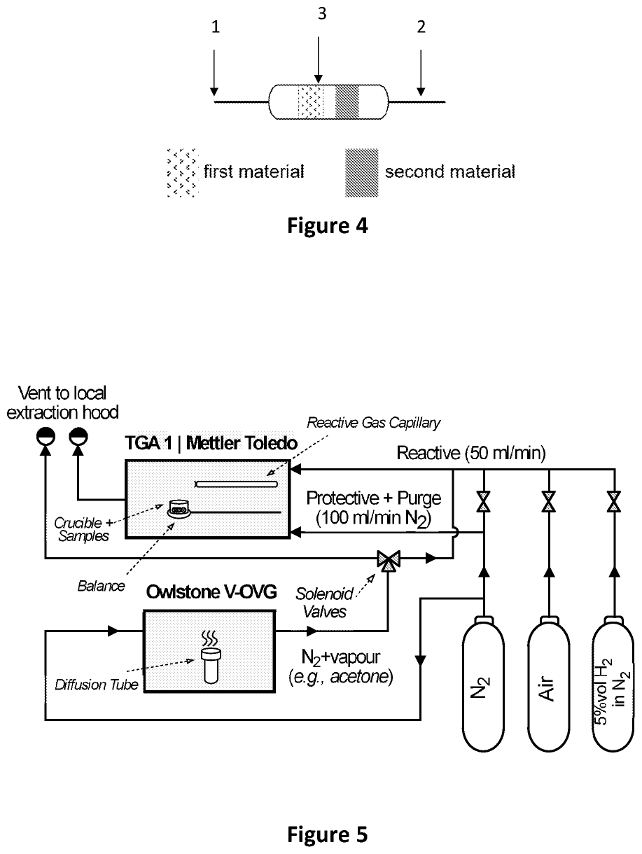

FIGS. 2 to 4 are vessels of the invention, showing a vessel (3) as well an input (1) and an output (2).

In some embodiments, the vessel is in a first state or in a second state. When the vessel is in the first state, the vessel is configured to convert a first fluid into a second fluid, as described herein. When the vessel is in the second state, the vessel is configured to convert a fourth fluid into a fifth fluid, as described herein.

In some embodiments, the vessel is configured to operate in a state or in a second state. When the vessel is configured to operate in the first state, the vessel is configured to convert a first fluid into a second fluid, as described herein. When the vessel is configured to operate in the second state, the vessel is configured to convert a fourth fluid into a fifth fluid, as described herein.

The first fluid of the second aspect may independently be the same as described herein in relation to the first fluid of the first aspect. The second fluid of the second aspect may independently be the same as described herein in relation to the second fluid of the first aspect. The third fluid of the second aspect may independently be the same as described herein in relation to the third fluid of the first aspect.

The fourth fluid of the second aspect may independently be the same as described herein in relation to the fourth fluid of the first aspect. The fifth fluid of the second aspect may independently be the same as described herein in relation to the fifth fluid of the first aspect.

The first material of the second aspect may independently be the same as described herein in relation to the first material of the first aspect. The second material of the second aspect may independently be the same as described herein in relation to the second material of the first aspect.

In some embodiments, the first material is in a first state or in a second state. When the first material is in the first state, the first material is configured to convert a first fluid into a second fluid, as described herein. When the first material is in the second state, the first material is configured to convert a fourth fluid into a fifth fluid, as described herein.

In some embodiments, the first material is configured to operate in a first state or in a second state. When the first material is configured to operate in the first state, the first material is configured to convert a first fluid into a second fluid, as described herein. When the first material is configured to operate in the second state, the first material is configured to convert a fourth fluid into a fifth fluid, as described herein.

In some embodiments, the vessel has an internal volume of from about 1 L to about 100 L. In some embodiments, the vessel has an internal volume of from about 1 L to about 75 L, from about 1 L to about 50 L, from about 1 L to about 25 L, from about 1 L to about 10 L, or from about 1 L to about 5 L. Preferably, the vessel has an internal volume of from about 1 L to about 22 L.

The vessel comprises an input. The input may be configured to accept the first fluid. The vessel comprises an output. The output may be configured to output the third fluid.

The first material is positioned between the input and the output of the vessel. As such, the first vessel is configured such that the first fluid can enter the vessel and pass across and/or through the first material. The first fluid is thereby converted into the second fluid.

The second material is positioned between the input and the output of the vessel. As such, the vessel is configured such that the second fluid can pass across and/or through the second material. The second fluid is thereby converted into the third fluid.

In some embodiments, a portion of the first fluid is converted into the second fluid whilst a portion of the second fluid is converted into the third fluid.

In some embodiments, the first material is comprised in a first section of the vessel. In some embodiments, the second material is comprised in a second section of the vessel. The first section and the second section may be positioned between the input and the output.

In some embodiments, the first material is comprised in a first section of the vessel. In some embodiments, the second material is comprised in the first section of the vessel. In some embodiments, the first material and second material are comprised in the first section of the vessel.

In some embodiments, the first material is comprised in a second section of the vessel. In some embodiments, the second material is comprised in the second section of the vessel. In some embodiments, the first material and second material are comprised in the second section of the vessel.

In some embodiments, the first section and the second section are spatially separate. That is, in some embodiments, the first section and the second section do not occupy the same space. In such embodiments, the first section may abut/be in contact with the second section. In some embodiments, the first section and second section may be separated by a porous material (such as a mesh, or an inert material such as Al₂O₃ or SiO₂).

In some embodiments, the first section and the second section are not spatially separate. For example, the vessel may comprise a section where the first section and second section overlap. For example, the vessel may comprise an overlap section. In such embodiments, the overlap section comprises the first material and the second material. In some embodiments, the first material and the second material may be separated by a porous material (such as a mesh or an inert material such as Al₂O₃ or SiO₂), or they be mixed with each other.

In some embodiments, the first section and second section overlap (for example the first section and second section overlap may completely). For example, the first section and/or the second section may be a mixture of the first material and the second material. The first material and second material may be separated by a porous material (such as a mesh), or they be mixed with each other.

In some embodiments, there is provided a system which comprises the vessel and one or more further vessels. In some embodiments, the system may comprise one or more further vessels configured to decrease the concentration of water in the third fluid (for example a dehumidifier and/or a vessel comprising a molecular sieve). For example, the system may comprise one or more further vessels configured to reduce the concentration of water in the third fluid to less than 1 vol %. For example, the further vessel may comprise an input which is coupled to the output of the vessel.

### Processes

In a third aspect, the invention relates to a process, the process comprising the steps of: contacting a first fluid with a first material in a first vessel to produce a second fluid, and contacting the second fluid with a second material in a second vessel to produce a third fluid;
wherein:
the first fluid comprises:
   a carbon containing compound,
   a hydrogen containing molecule that is not a hydrocarbon, or
   a combination of a carbon containing compound and a hydrogen containing molecule that is not a hydrocarbon;
   (i) when the first fluid comprises a carbon containing compound:
      the second fluid comprises carbon dioxide and at least one impurity;
      the third fluid comprises carbon dioxide and optionally at least one impurity; and
      the concentration of carbon dioxide in the third fluid is greater than the concentration of carbon dioxide in the second fluid;
   (ii) when the first fluid comprises a hydrogen containing molecule that is not a carbon containing compound:
      the second fluid comprises water, and at least one impurity;
      the third fluid comprises water and optionally at least one impurity; and
      the concentration of water in the third fluid is greater than the concentration of water in the second fluid;
   (iii) when the first fluid comprises a combination of a carbon containing compound and a hydrogen containing molecule that is not a carbon containing compound:
      the second fluid comprises carbon dioxide, water, and at least one impurity;
      the third fluid comprises carbon dioxide, water and optionally at least one impurity; and
      the concentration of carbon dioxide in the third fluid is greater than the concentration of carbon dioxide in the second fluid.

The process may comprise the steps of providing a first vessel (which may comprise the first material) and/or providing a second vessel (which may comprise the second material).

The first vessel of the third aspect may independently be the same as described herein in relation to the first vessel of the first aspect. The second vessel of the third aspect may independently be the same as described herein in relation to the second vessel of the first aspect.

The first fluid of the third aspect may independently be the same as described herein in relation to the first fluid of the first aspect. The second fluid of the third aspect may independently be the same as described herein in relation to the second fluid of the first aspect. The third fluid of the third aspect may independently be the same as described herein in relation to the third fluid of the first aspect.

The first material of the third aspect may independently be the same as described herein in relation to the first material of the first aspect. The second material of the third aspect may independently be the same as described herein in relation to the second material of the first aspect.

The process may comprise the step of heating the first vessel to a temperature (for example an internal temperature) of from about 300° C. to about 1000° C. For example, the process may comprise the step of heating the first vessel to a temperature (for example an internal temperature) of from about 300° C. to about 800° C. For example, the process may comprise the step of heating the first vessel to a temperature (for example an internal temperature) of from about 350° C. to about 750° C.

The process may comprise the step of heating the first vessel to a temperature (for example an internal temperature) of from about 300° C. to about 1000° C., whilst maintaining the pressure inside the first vessel at from about 1 bar to about 10 bar. For example, the process may comprise the step of heating the first vessel to a temperature (for example an internal temperature) of from about 300° C. to about 800° C., whilst maintaining the pressure inside the first vessel at from about 1 bar to about 10 bar. For example, the process may comprise the step of heating the first vessel to a temperature (for example an internal temperature) of from about 350° C. to about 750° C., whilst maintaining the pressure inside the first vessel at from about 1 bar to about 10 bar.

The process may comprise the step of heating the second vessel to a temperature (for example an internal temperature) of from about 300° C. to about 1000° C. For example, the process may comprise the step of heating the second vessel to a temperature (for example an internal temperature) of from about 300° C. to about 800° C. For example, the process may comprise the step of heating the second vessel to a temperature (for example an internal temperature) of from about 350° C. to about 750° C.

The process may comprise the step of heating the second vessel to a temperature (for example an internal temperature) of from about 300° C. to about 1000° C., whilst maintaining the pressure inside the second vessel at from about 1 bar to about 10 bar. For example, the process may comprise the step of heating the second vessel to a temperature (for example an internal temperature) of from about 300° C. to about 800° C., whilst maintaining the pressure inside the second vessel at from about 1 bar to about 10 bar. For example, the process may comprise the step of heating the second vessel to a temperature (for example an internal temperature) of from about 350° C. to about 750° C., whilst maintaining the pressure inside the second vessel at from about 1 bar to about 10 bar.

In some embodiments, the process comprises the step of providing one or more further vessels. In some embodiments, the one or more further vessels is configured to decrease the concentration of water in the third fluid (for example a dehumidifier and/or a vessel comprising a molecular sieve). For example, the one or more further vessels may be configured to reduce the concentration of water in the third fluid to less than 1 vol %. For example, the further vessel may comprise an input which is coupled to the output of the second vessel. The process may comprise the step of reducing the concentration of water in the third fluid, for example to less than 1 vol %.

In some embodiments, the first material is in a first state or in a second state. When the first material is in the first state, the first material is configured to convert a first fluid into a second fluid, as described herein. When the first material is in the second state, the first material is configured to convert a fourth fluid into a fifth fluid, as described herein.

In some embodiments, the process comprises the steps of contacting a fourth fluid as described herein with the first material in the first vessel to produce a fifth fluid as described herein.

In some embodiments, contacting the first fluid with the first material results in the first material being (at least partially) reduced to a reduced first material (for example, the first material is in a second state as described herein). In some embodiments, the process comprises the steps of contacting a fourth fluid as described herein with the reduced first material in the first vessel to produce a fifth fluid as described herein.

The fourth fluid of the third aspect may independently be the same as described herein in relation to the fourth fluid of the first aspect. The fifth fluid of the third aspect may independently be the same as described herein in relation to the fifth fluid of the first aspect.

In some embodiments, the process comprises the step of providing one or more further vessels. In some embodiments, the one or more further vessels is configured to decrease the concentration of water in the fifth fluid (for example a dehumidifier and/or a vessel comprising a molecular sieve). For example, the one or more further vessels may be configured to reduce the concentration of water in the fifth fluid to less than 1 vol %. For example, the further vessel may comprise an input which is coupled to the output of the first vessel. The process may comprise the step of reducing the concentration of water in the fifth fluid, for example to less than 1 vol %.

In a fourth aspect, the invention relates to a process, the process comprising the steps of: contacting a first fluid with a first material in a vessel to produce a second fluid, and contacting the second fluid with a second material in the vessel to produce a third fluid;
wherein:
the first fluid comprises:
   a carbon containing compound,
   a hydrogen containing molecule that is not a hydrocarbon, or
   a combination of a carbon containing compound and a hydrogen containing molecule that is not a hydrocarbon;
   (i) when the first fluid comprises a carbon containing compound:
      the second fluid comprises carbon dioxide and at least one impurity;
      the third fluid comprises carbon dioxide and optionally at least one impurity; and
      the concentration of carbon dioxide in the third fluid is greater than the concentration of carbon dioxide in the second fluid;
   (ii) when the first fluid comprises a hydrogen containing molecule that is not a carbon containing compound:
      the second fluid comprises water, and at least one impurity;
      the third fluid comprises water and optionally at least one impurity; and
      the concentration of water in the third fluid is greater than the concentration of water in the second fluid;
   (iii) when the first fluid comprises a combination of a carbon containing compound and a hydrogen containing molecule that is not a carbon containing compound:
      the second fluid comprises carbon dioxide, water, and at least one impurity;
      the third fluid comprises carbon dioxide, water and optionally at least one impurity; and
      the concentration of carbon dioxide in the third fluid is greater than the concentration of carbon dioxide in the second fluid.

The process may comprise the steps of providing a vessel (which may comprise the first material and second material).

The vessel of the fourth aspect may independently be the same as described herein in relation to the first vessel of the first aspect.

The first fluid of the fourth aspect may independently be the same as described herein in relation to the first fluid of the first aspect. The second fluid of the fourth aspect may independently be the same as described herein in relation to the second fluid of the first aspect. The third fluid of the fourth may independently be the same as described herein in relation to the third fluid of the first aspect.

The first material of the fourth aspect may independently be the same as described herein in relation to the first material of the first aspect. The second material of the fourth aspect may independently be the same as described herein in relation to the second material of the first aspect.

The process may comprise the steps of heating the vessel to a temperature (for example an internal temperature) of from about 300° C. to about 1000° C. For example, the process may comprise the steps of heating the vessel to a temperature (for example an internal temperature) of from about 300° C. to about 800° C. For example, the process may comprise the steps of heating the vessel to a temperature (for example an internal temperature) of from about 350° C. to about 750° C. For example, the process may comprise the steps of heating the vessel to a temperature (for example an internal temperature) of from about 350° C. to about 650° C.

The process may comprise the steps of heating the vessel to a temperature (for example an internal temperature) of from about 300° C. to about 1000° C., whilst maintaining the pressure inside the vessel at from about 1 bar to about 10 bar. For example, the process may comprise the steps of heating the vessel to a temperature (for example an internal temperature) of from about 300° C. to about 800° C., whilst maintaining the pressure inside the vessel at from about 1 bar to about 10 bar. For example, the process may comprise the steps of heating the vessel to a temperature (for example an internal temperature) of from about 350° C. to about 750° C., whilst maintaining the pressure inside the vessel at from about 1 bar to about 10 bar. For example, the process may comprise the steps of heating the vessel to a temperature (for example an internal temperature) of from about 350° C. to about 650° C., whilst maintaining the pressure inside the vessel at from about 1 bar to about 10 bar.

In some embodiments, the process comprises the step of providing one or more further vessels. In some embodiments, the one or more further vessels is configured to decrease the concentration of water in the third fluid (for example a dehumidifier and/or a vessel comprising a molecular sieve). For example, the one or more further vessels may be configured to reduce the concentration of water in the third fluid to less than 1 vol %. For example, the further vessel may comprise an input which is coupled to the output of the vessel. The process may comprise the step of reducing the concentration of water in the third fluid, for example to less than 1 vol %.

In some embodiments, the first material is in a first state or in a second state. When the first material is in the first state, the first material is configured to convert a first fluid into a second fluid, as described herein. When the first material is in the second state, the first material is configured to convert a fourth fluid into a fifth fluid, as described herein.

In some embodiments, the process comprises the steps of contacting a fourth fluid as described herein with the first material in the vessel to produce a fifth fluid as described herein.

In some embodiments, contacting the first fluid with the first material results in the first material being (at least partially) reduced to a reduced first material (for example, the first material is in a second state as described herein). In some embodiments, the process comprises the steps of contacting a fourth fluid as described herein with the reduced first material in the vessel to produce a fifth fluid as described herein.

The fourth fluid of the fourth aspect may independently be the same as described herein in relation to the fourth fluid of the first aspect. The fifth fluid of the fourth aspect may independently be the same as described herein in relation to the fifth fluid of the first aspect.

In some embodiments, the process comprises the step of providing one or more further vessels. In some embodiments, the one or more further vessels is configured to decrease the concentration of water in the fifth fluid (for example a dehumidifier and/or a vessel comprising a molecular sieve). For example, the one or more further vessels may be configured to reduce the concentration of water in the fifth fluid to less than 1 vol %. For example, the further vessel may comprise an input which is coupled to the output of the vessel. The process may comprise the step of reducing the concentration of water in the fifth fluid, for example to less than 1 vol %.

In a fifth aspect, the invention relates to a use of a system described herein, for example for producing hydrogen and/or carbon dioxide.

In a sixth aspect, the invention relates to a use of a vessel described herein, for example for producing hydrogen and/or carbon dioxide.

In a seventh aspect, the invention relates to a process of producing carbon dioxide and/or hydrogen using a system described herein.

In an eighth aspect, the invention relates to a process of producing carbon dioxide and/or hydrogen using a vessel described herein.

In a ninth aspect, the invention relates to a building comprising a system and/or vessel as described herein.

### Definitions

Any fluid described herein may be a gas or a liquid. As such, the term fluid refers to a gas, a liquid, or a combination of a gas and a liquid. Whether a specific fluid component is a gas or a liquid will depend on its temperature and/or pressure. In some embodiments, the fluid described herein is a liquid. Preferably, in some embodiments, the fluid described herein is a gas.

The term “water” refers to fluid water. That is, the water described herein may be liquid water or gaseous water (sometimes referred to as steam or water vapour). In some embodiments, the water described herein is liquid water. Preferably, the water described herein is gaseous water.

The term vol % means volume %. Unless otherwise stated, the term vol % refers to the volume % of a specific component relative to the total volume of the composition that the specific component is comprised in.

The materials described herein are described as being between inputs and outputs of vessels. In such embodiments, the materials may be positioned in any way such that the relevant fluid passes across and/or through the material when moving from the input towards the output. The materials may be positioned spatially in any way to achieve this purpose.

The vessels and fluids described herein are described as being configured to allow or being able to pass across and/or through the relevant material. In this way, the fluid can interact chemically with the relevant material to result in the fluid conversions described herein. For example, the fluid may diffuse into or adsorb onto the material and thereby be converted to a different fluid. Any such interaction of fluid and vessel/material is intended to be encompassed by the invention as described herein.

As used herein, the term “A is coupled to B” means that A is in fluid connection with B. As used herein, the term “A is between B and C” means that A is between B and C and is in fluid connection with B and C.

When component A is described as being “coupled” to component B, it means that A is suitable for and is coupled to B. That is, A has features that make it suitable to be coupled to B, and B has features that make it suitable to be coupled to A.

The term “in fluid connection with” means that there is a path that a fluid can flow between specific components. The skilled person understands how each component described herein can be made in fluid connection with every other component described herein.

Components described herein may be coupled to other components described herein. For example, the components may be coupled directly to other components. In such embodiments, the relevant components may be joined directly to each other so that they are in fluid connection with each other. In some embodiments, the relevant components may be coupled to each other by a tubular member.

The term tubular member includes pipes, conduits, tubing, hoses or any other member that provides the function of allowing a fluid to move within its core. The cross section of the tubular member may be circular, substantially circular, square, rectangular, or any other cross section able to provide the required function.

The vessels described herein may be combustion vessels. That is, the vessels described herein may be configured to allow a combustion reaction to proceed within them. The features of such vessels depend on the kind of combustion reaction that occurs within and will be known to the skilled person. Examples, of combustion vessels include fixed bed reactors (such as a packed bed reactors) or fluidised bed reactors. In some embodiments, the combustion vessel(s) is a chemical looping combustion vessel (for example, a fluidised bed reactor comprising a material configured to allow a chemical looping combustion reaction).

As described herein, a reducing gas is a gas that is capable of reducing a material as described herein (for example, the first material). In this way, the first material becomes partially or full oxidised.

The term mixed ionic-electronic conductor (MIEC) is known to the skilled person who clearly understands its bounds. An MIEC is any material that has significant electronic and ionic conductions (for example at standard temperature and pressure). A MIEC may be a non-stoichiometric compounds such as a non-stoichiometric oxide. For example, a MIEC may be a perovskite type metal oxide or a fluorite type metal oxide

In some embodiments, the term perovskite type metal oxide may be replaced with the term perovskite metal oxide or perovskite. The second metal oxide may also be a perovskite type metal oxide at the temperature used in the processes described herein.

A first metal oxide may satisfy the change in standard Gibbs energy defined herein at its operating temperature (e.g. at the temperature of a process as described herein). also be a perovskite type metal oxide at the temperature used in the processes described herein.

As used herein, δ represents the non-stoichiometry of a material/metal oxide and is from 0 to 0.5.

### EXAMPLES

Materials used herein are commercially available and can be obtained from Sigma Aldrich or Fisher Scientific.

The planetary ball mill used is the Planetary Mono Mill PULVERISETTE 6 classic line, Manufactured by Fritsch.

The thermogravimetric analyser setup used is the Owlstone V-OVG combined with a TGA/DSC 1 Mettler Toledo thermogravimetric analyser (see FIG. 5).

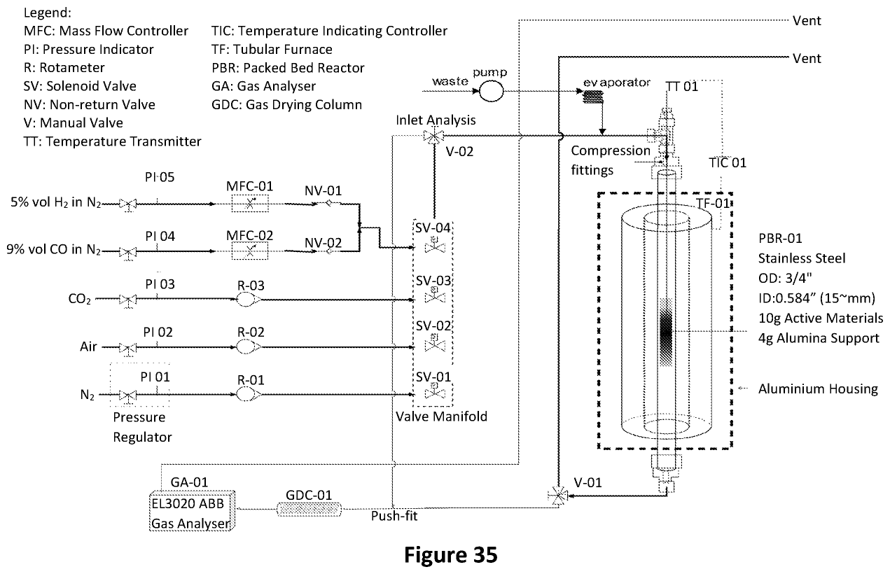

The packed bed reactor setup used was designed and constructed in house. A diagrammatic description is presented in FIG. 35. A vertical-oriented ¾-inch stainless steel tube was used as the packed bed reactor by first packing the tube with quartz wool. The tube was then filled with 10 g of the sample material followed by 4 g inert Al₂O₃ to form the packed bed and the assembly was placed within a tubular furnace. A Type-K thermocouple was used to probe the centre of the active bed materials for temperature control and temperature logging. An in-line gas analyser (ABB URAS 26) was used to determine the outlet gas composition.

### Example 1—Material Synthesis

### Perovskite Type Metal Oxides

Perovskite type metal oxides were synthesised using method 1 or method 2 below.

### Method 1 (Ball Milling):

### Strontium Ferrite Perovskite:

SrCO₃ and Fe₂O₃ were weighed and manually mixed in a 2:1 molar ratio, then placed in a stainless steel crucible with 13 stainless steel balls (20 mm diameter). Then, 60 ml of anhydrous ethanol was added per each 0.25 mol of Fe₂O₃ added. The crucible was placed in the planetary ball mill (Pulversitte 6) and ball-milled 15 times, each time for 2 min at 600 rpm, followed by 20 min rest. The sample was then dried in an oven at 50° C. for 24 h, then calcined 3 times at 1000° C. for 4 h, allowing cooling to room temperature between cycles and using a ramp rate of 5° C./min.

### Other Perovskites:

Other perovskites were synthesised using method 1 wherein SrCO₃ was replaced with the appropriate amount of the corresponding metal carbonate. The appropriate amounts of the corresponding metal carbonate and Fe₂O₃ were calculated so that the molar ratio of the metal to Fe used was 1:1. For example, a lanthanum ferrite perovskite (LaFeO₃) was synthesised using the appropriate amount of La₂(CO₃)₂.

Additionally, further perovskites were synthesised using method 1 but using a second metal precursor compound. For example, Sr_{0.95}Ce_{0.05}FeO₃ was synthesised by using an appropriate amount of CeO₂ mixed with the SrCO₃ and Fe₂O₃. The appropriate amount of the CeO₂, SrCO₃ and Fe₂O₃ was calculated so that the molar ratio of the Sr to Fe used was 0.95:1, and the molar ratio of the Ce to Fe used was 0.05:1.

For example, SrFe_{0.95}Cu_{0.05}O_{3-δ} was synthesised by using an appropriate amount of CuO mixed with the SrCO₃ and Fe₂O₃. The appropriate amount of the CuO, SrCO₃ and Fe₂O₃ was calculated so that the molar ratio of the Fe to Sr used was 0.95:1, and the molar ratio of the Cu to Sr used was 0.05:1.

### Method 2 (Wet Mixing):

### Strontium Ferrite Perovskite:

Sr(NO₃)₂ and Fe(NO₃)₃ (in a 1:1 molar ratio) were dissolved in deionised water, heated to 50° C. and stirred for 30 min. Then, citric acid (CA) was added and stirred for another 30 min. The amount of CA used was calculated so that the molar ratio of CA:metal cations in the resulting solution was 3:1. Ethylene glycol (EG) was added to the resulting mixture and stirred until the formation of a sticky gel at 80° C. The amount of EG used was calculated so that the molar ratio of EG to CA used was 2:1. The gel was dried overnight at 130° C., followed by calcination at 450° C. for 4 h with a ramping ratio of 5° C./min, then at 900° C. for 6 h with the same ramp rate.

### Other Perovskites:

Other perovskites were synthesised using method 2 wherein Sr(NO₃)₂ was replaced with the appropriate amount of the corresponding metal nitrate. The appropriate amounts of the corresponding metal nitrate and Fe(NO₃)₃ were calculated so that the molar ratio of the metal to Fe used was 1:1. For example, a lanthanum ferrite perovskite was synthesised using the appropriate amount of La(NO₃)₃.

Additionally, further perovskites were synthesised using method 2 but using further metal precursor compounds. For example, La_{0.75}Sr_{0.25}FeO_{3-δ} was synthesised by using an appropriate amount of Sr(NO₃)₂ and La(NO₃)₃ with the Fe(NO₃)₃. The appropriate amounts of the Sr(NO₃)₂, La(NO₃)₃ and Fe(NO₃)₃ were calculated so that the molar ratio of the La to Fe used was 0.75:1, and the molar ratio of the Sr to Fe used was 0.25:1.

For example, La_{0.6}Ca_{0.4}Fe_{0.4}Mn_{0.6}O₃ was synthesised by using an appropriate amount of MnCO₃, CaCO₃ and La(NO₃)₃ with the Fe(NO₃)₃. The appropriate amounts of the MnCO₃, CaCO₃, La(NO₃)₃ and Fe(NO₃)₃ were calculated so that the molar ratio of the La:Ca:fe:Mn used was 0.6:0.4:0.4:0.6.

For example, Sr_{0.5}La_{0.5}Fe_{0.5}Ni_{0.25}Ti_{0.25}O₃ was synthesised by using an appropriate amount of Ni(NO₃)₃, TiO₂ and La(NO₃)₃ with the Sr(NO₃)₂ and Fe(NO₃)₃. The appropriate amounts of the Ni(NO₃)₃, TiO₂, La(NO₃)₃, Sr(NO₃)₂ and Fe(NO₃)₃ were calculated so that the molar ratio of the Sr:La:Fe:Ni:Ti used was 0.5:0.5:0.5:025:0.25.

### Perovskite Type Metal Oxide Composites

Perovskite type metal oxide composites were synthesised using method 3 or method 4 below.

### Method 3 (Ball Milling):

Perovskite type metal oxides (synthesised according to method 1 or method 2 above) and Fe₂O₃ were placed in a crucible in a 1:9 molar ratio. Then, 60 ml of anhydrous ethanol was added per each 0.25 mol of Fe₂O₃ added. The crucible was placed in the planetary ball mill (Pulversitte 6) and ball-milled 30 times, each for 2 min active milling and 20 min pause. The sample was then dried in an oven at 50° C. for 24 h, then calcined at 900° C. for 6 h.

For example, the perovskite type metal oxides used were: strontium ferrite perovskite and lanthanum ferrite perovskite.

### Method 4 (Wet Mixing):

### Strontium Ferrite Perovskite Composite:

Composite materials were prepared using a modified Pechini method. Fe₂O₃ powder was dispersed in an excess of 60 vol % ethanol solution and stirred for 5 min, then settled for 3 h and the excess ethanol was decanted, to form an Fe₂O₃ paste.

Sr(NO₃)₂ and Fe(NO₃)₃ (in a 1:1 molar ratio) were dissolved in deionised water, heated to 50° C. and stirred for 30 min. Then, citric acid (CA) was added and stirred for another 30 min to form a CA containing solution. The amount of CA used was calculated so that the molar ratio of CA:metal cations in the resulting solution was 3:1.

An amount of the Fe₂O₃ paste was mixed with an amount of the CA containing solution and stirred for 30 min at 50° C., to form a mixture. The amount of Fe₂O₃ paste and CA containing solution used was calculated so that the molar ratio of the Fe₂O₃ to resulting perovskite (SrFeO₃) was 9:1. Ethylene glycol (EG) was added to the resulting mixture and stirred until the formation of a sticky gel at 80° C. The amount of EG used was calculated so that the molar ratio of EG to CA used was 2:1. The gel was dried overnight at 130° C., followed by calcination at 450° C. for 4 h with a ramping ratio of 5° C./min, then at 900° C. for 6 h with the same ramp rate.

### Other Perovskite Composites:

Other perovskite composites were synthesised using method 4 wherein Sr(NO₃)₂ was replaced with the appropriate amount of the corresponding metal nitrate. The appropriate amounts of the corresponding metal nitrate and Fe(NO₃)₃ were calculated so that the molar ratio of the metal to Fe used was 1:1. For example, a lanthanum ferrite perovskite composite was synthesised using the appropriate amount of La(NO₃)₃. Gd_{0.3}Ce_{0.7}O₂ was synthesised using method 4 wherein Sr(NO₃)₂ and Fe(NO₃)₃ were replaced with an appropriate amount of Gd(NO₃)₃ and Ce(NO₃)₃. The appropriate amounts of the Gd(NO₃)₃ and Ce(NO₃)₃ were calculated so that the molar ratio of the Gd:Ce used was 0.3:0.7.

### Promoted Perovskite Type Metal Oxide Composites

Promoted perovskite type metal oxide composites were synthesised using method 5 below.

### Method 5:

### Potassium Promoted Strontium Ferrite Perovskite Composite:

Potassium promoted strontium ferrite perovskite composites were synthesised by depositing KNO₃ onto a strontium ferrite perovskite composite (synthesised according to method 4 or method 5 above) using an incipient wetness method.

KNO₃ was dissolved in deionised water, and the resulting solution was added dropwise to particles of the strontium ferrite perovskite composite under constant manual stirring. The resulting material was then dried at 120° C. for 12 h in an oven, followed by calcination at 600° C. for 4 h with a ramp rate of 5° C./min. The obtained loading was 10 wt. % based on the oxide of the promoting metal. That is, the amount of KNO₃ used was determined by calculating an amount of K₂O that was 10 wt. % of the resulting promoted composite and then calculating the amount of KNO₃ needed to provide this amount of K₂O (noting that the nitrate decomposes to the corresponding oxide during the thermal process).

### Other Promoted Strontium Perovskite Composites:

Other promoted strontium perovskite composites were synthesised using method 5 wherein KNO₃ was replaced with the appropriate amount of the corresponding promoter nitrate. For example, a sodium promoted strontium ferrite perovskite composite was synthesised using the appropriate amount of NaNO₃. For example, a caesium promoted strontium ferrite perovskite composite was synthesised using the appropriate amount of CsNO₃. For example, a silver promoted strontium ferrite perovskite composite was synthesised using the appropriate amount of AgNO₃.

### Other Promoted Perovskite Composites:

Other promoted perovskite composites were synthesised using method 5 wherein the strontium ferrite perovskite composite was replaced with the appropriate amount of the corresponding metal oxide type perovskite composite.

For example, a potassium promoted lanthanum perovskite composite was synthesised according to method 5, wherein the strontium perovskite composite was replaced with a lanthanum perovskite composite. For example, a sodium promoted lanthanum perovskite composite was synthesised according to method 5, wherein the strontium perovskite composite was replaced with a lanthanum perovskite composite, and the KNO₃ was replaced with the appropriate amount of NaNO₃. For example, a caesium promoted lanthanum perovskite composite was synthesised according to method 5, wherein the strontium perovskite composite was replaced with a lanthanum perovskite composite, and the KNO₃ was replaced with the appropriate amount of CsNO₃.

### Example 2

Experimental investigations were carried out in a Mettler Toledo's TGA 1 unit with a horizontal reaction chamber (FIG. 5). A balance arm was located in the middle of the chamber, upon where an alumina crucible containing a test material was placed. The total gas flowrate through the chamber was 150 mL/min, created using the reducing or oxidising components and diluting gases. The mixture was created using Owlstone V-OVG, where the composition of the gas was manipulated by changing the setpoint temperature of the Owlstone unit.

Experiments were carried out by heating the sample from 50 to 900° C., then cooling it back to 50° C.; both steps with a rate of 10° C./min. The steps also differed in the composition of the gas introduced to the TGA analyser.

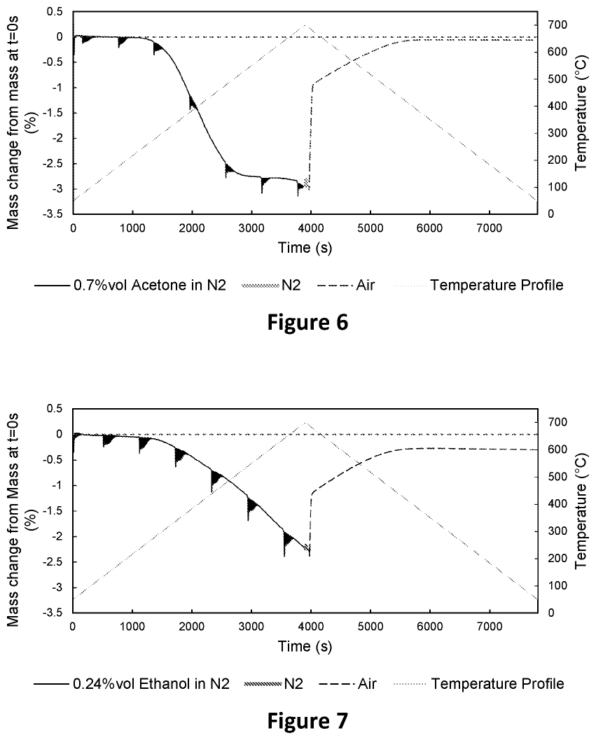

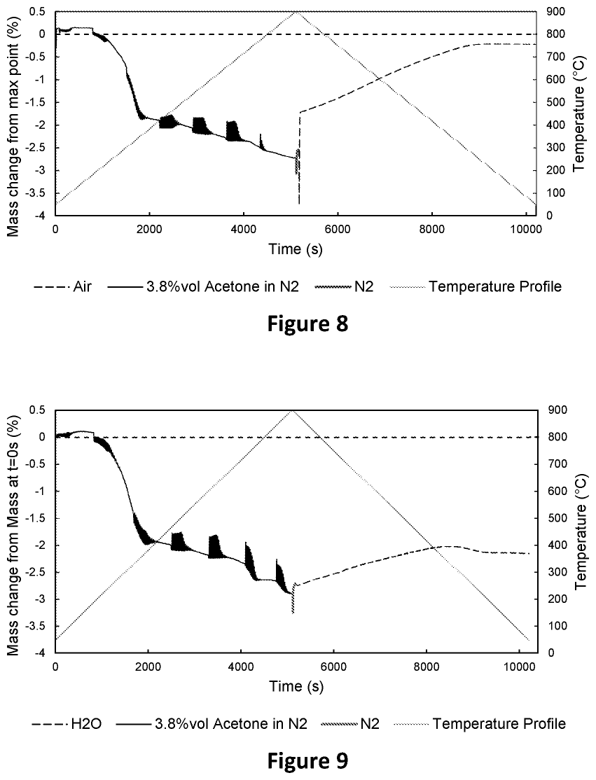

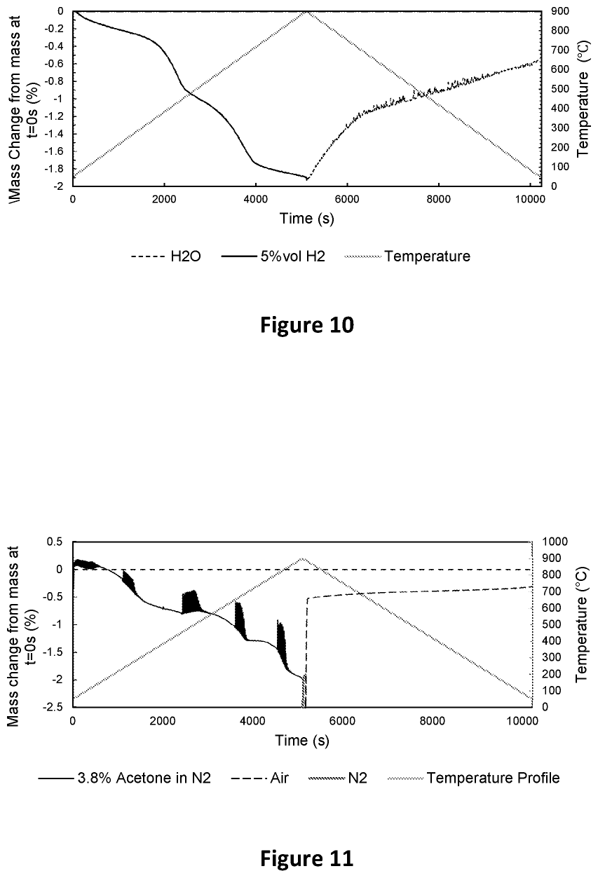

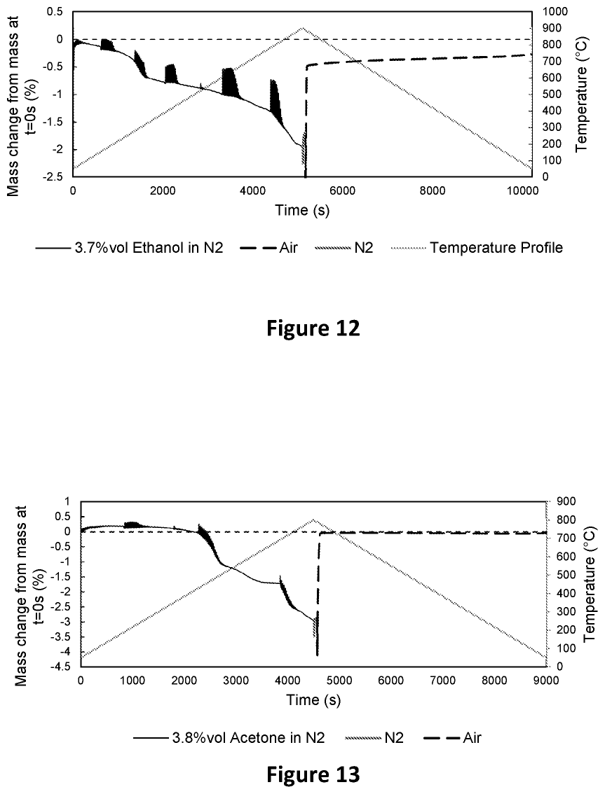

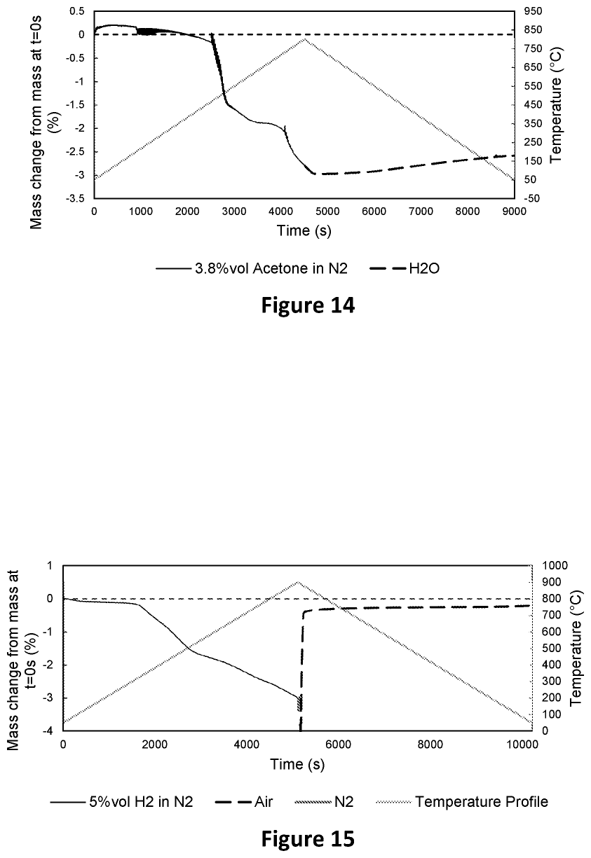

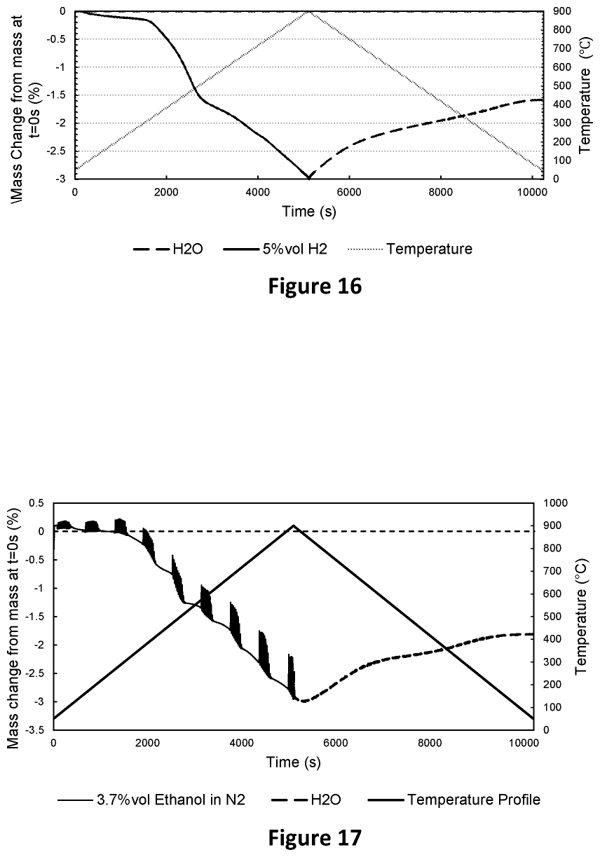

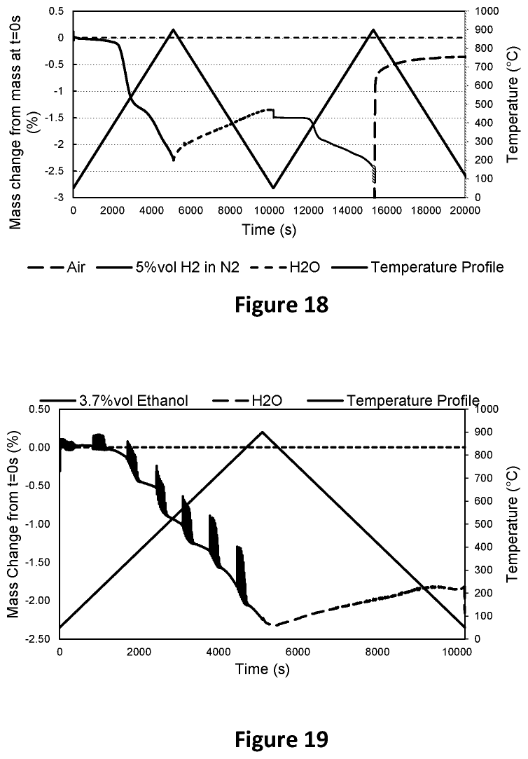

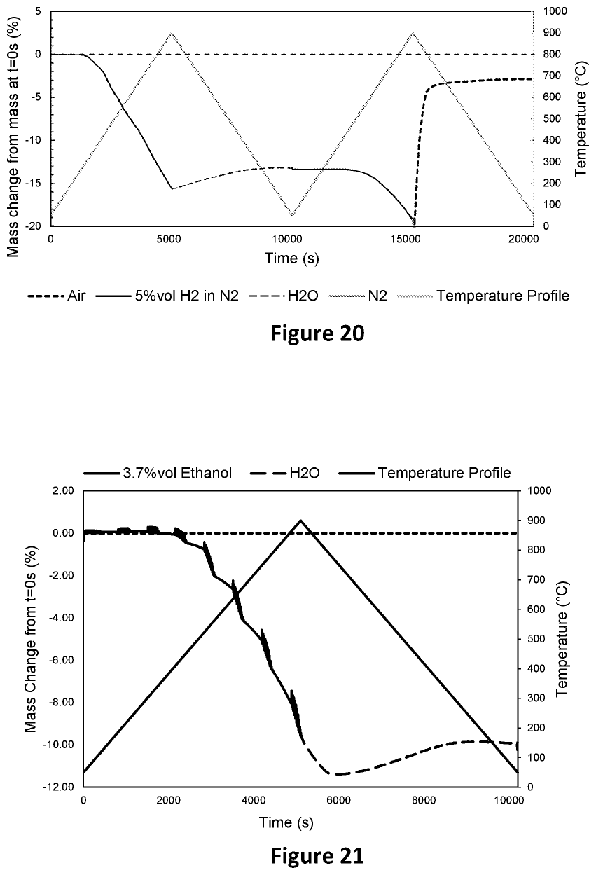

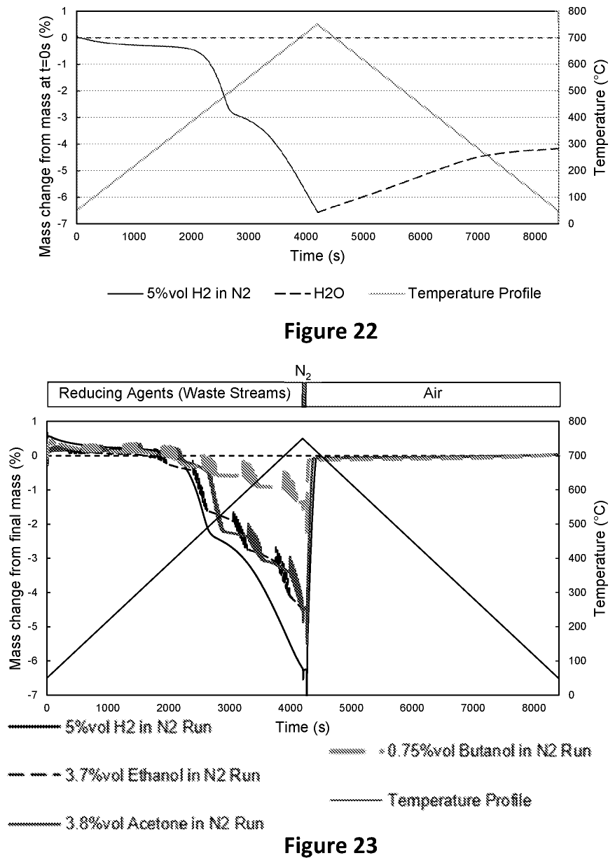

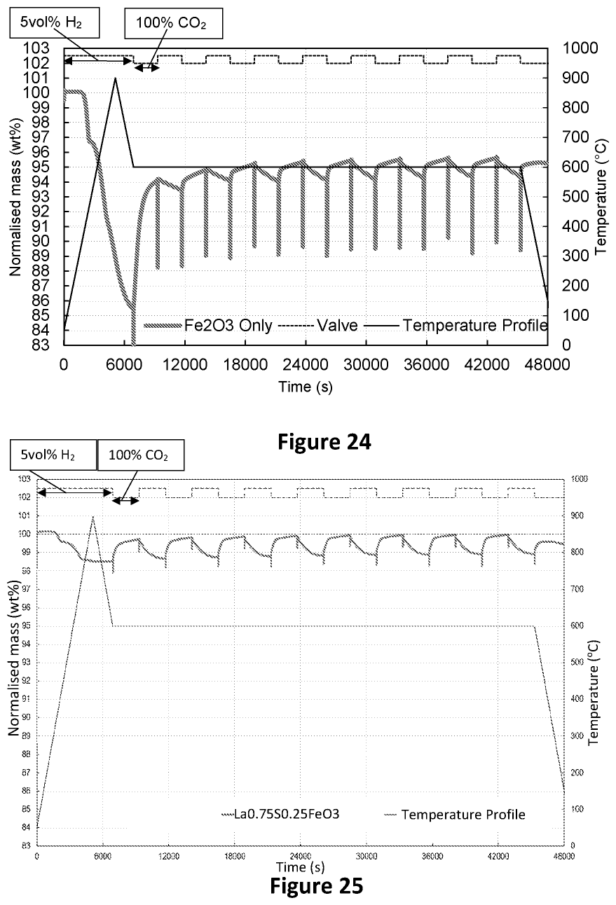

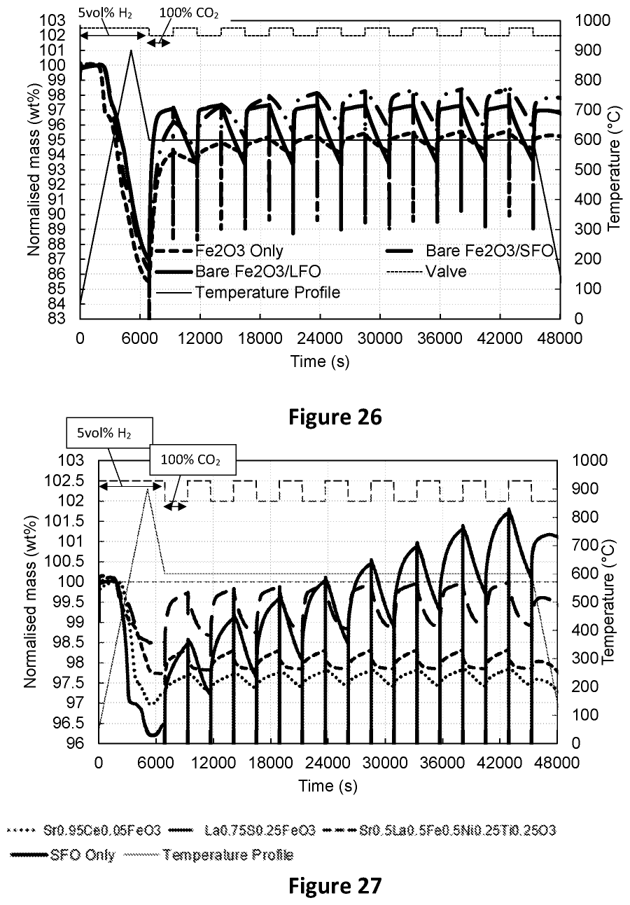

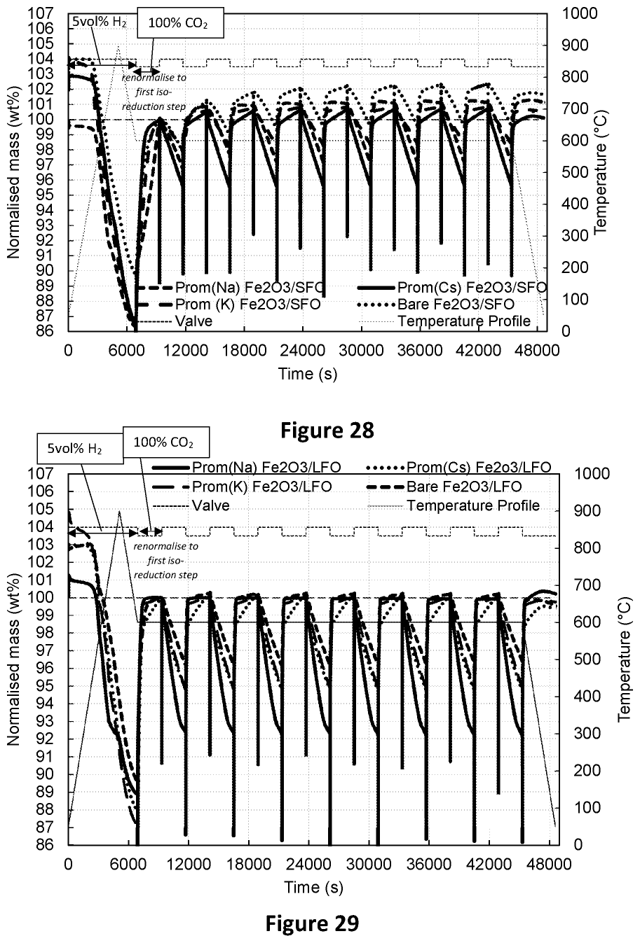

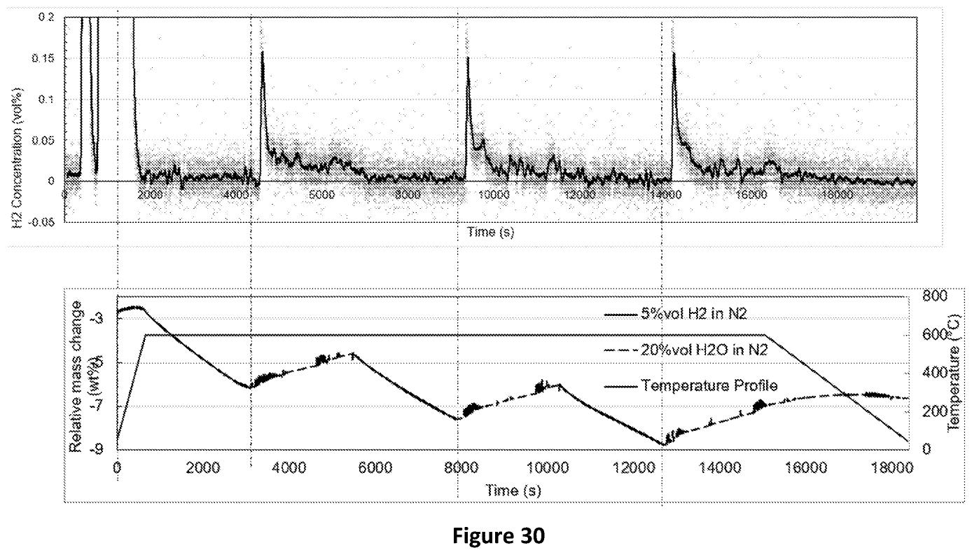

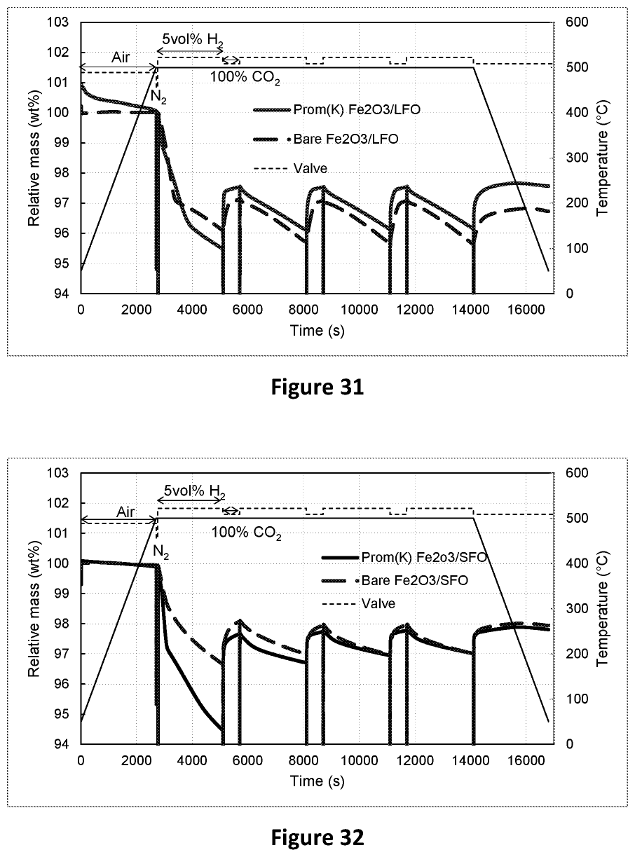

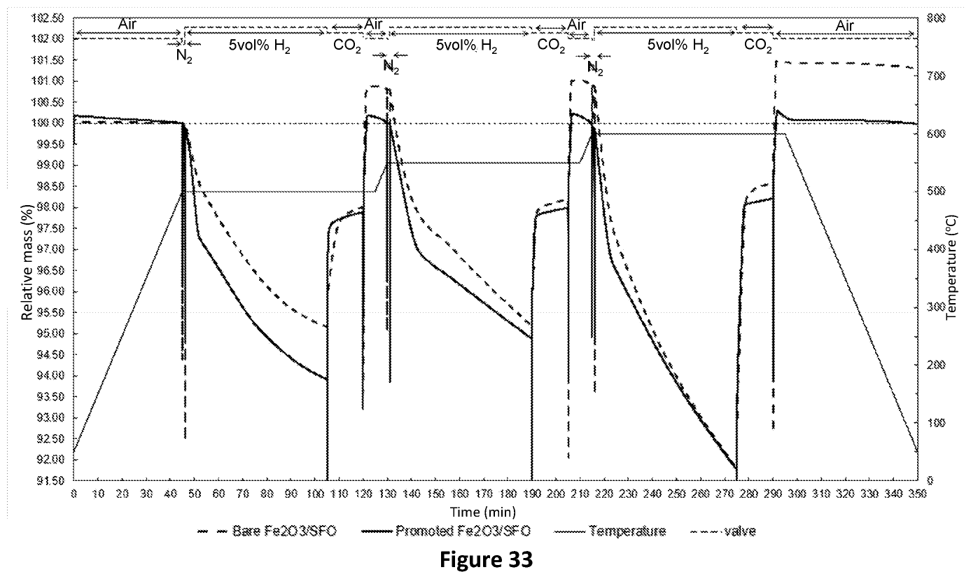

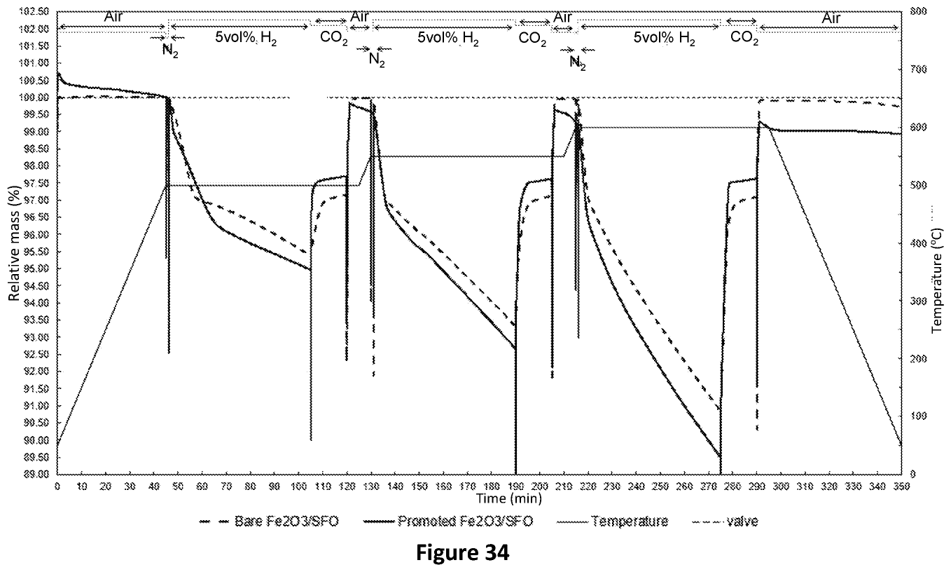

The materials tested all showed exceptional cyclability, oxidation capability and water splitting (hydrogen production) capability. Of particular note are the materials shown in Table 1 and FIGS. 1 to 34.

TABLE 1

| FIG. | Material | Step I | Step II | Step III | Step IV |
|---|---|---|---|---|---|
| 6 | SrFe_{0.95}Cu_{0.05}O_{3-δ} | 50° C. to 700° C. | 700° C. to 50° C. | — | — |
| | | at 10° C./min | at −10° C./min | | |
| | | (under 0.7% vol | (under N2 for | | |
| | | Acetone in N₂) | the first 60 sec | | |
| | | | followed by | | |
| | | | Air) | | |
| 7 | SrFe_{0.95}Cu_{0.05}O_{3-δ} | 50° C. to 700° C. | 700° C. to | — | — |
| | | at 10° C./min | 50° C. | | |
| | | (under 0.24% vol | at −10° C./min | | |
| | | Ethanol in N₂) | (under N₂ for | | |
| | | | the first 60 | | |
| | | | sec followed | | |
| | | | by Air) | | |
| 8 | Ag (15 wt. %) on | 50° C. to 900° C. | 900° C. to | — | — |
| | SrCeFeO_{3-δ} | at 10° C./min | 50° C. | | |
| | | (under 3.8% vol | at −10° C./min | | |
| | | Acetone in N₂) | (under N₂ for | | |
| | | | the first 60 | | |
| | | | sec followed | | |
| | | | by Air) | | |
| 9 | Ag (15 wt. %) on | 50° C. to 900° C. | 900° C. to | — | — |
| | SrCeFeO_{3-δ} | at 10° C./min | 50° C. | | |
| | | (under 3.8% vol | at −10° C./min | | |
| | | Acetone in N₂) | (under N₂ for | | |
| | | | the first 60 | | |
| | | | sec followed | | |
| | | | by Humid | | |
| | | | N₂) | | |
| 10 | La_{0.75}Sr_{0.25}FeO_{3-δ} | 50° C. to 900° C. | 900° C. to | — | — |
| | | at 10° C./min | 50° C. | | |
| | | (under 5% vol H₂ | at −10° C./min | | |
| | | in N₂) | (under | | |
| | | | humid N₂) | | |
| 11 | La_{0.75}Sr_{0.25}FeO_{3-δ} | 50° C. to 900° C. | 900° C. to | — | — |
| | | at 10° C./min | 50° C. | | |
| | | (under 3.8% vol | at −10° C./min | | |
| | | Acetone in N₂) | (under | | |
| | | | humid N₂) | | |
| 12 | La_{0.75}Sr_{0.25}FeO_{3-δ} | 50° C. to 900° C. | 900° C. to | — | — |
| | | at 10° C./min | 50° C. | | |
| | | (under 3.7% vol | at −10° C./min | | |
| | | Ethanol in N₂) | (under | | |
| | | | humid N₂) | | |
| 13 | NiFe₂O₄ | 50° C. to 800° C. | 800° C. to | — | — |
| | | at 10° C./min | 50° C. | | |
| | | (under 3.8% vol | at −10° C./min | | |
| | | Acetone in N₂) | (under 60 sec | | |
| | | | N2 followed | | |
| | | | by Air) | | |
| 14 | NiFe₂O₄ | 50° C. to 800° C. | 800° C. to | — | — |
| | | at 10° C./min | 50° C. | | |
| | | (under 3.8% vol | at −10° C./min | | |
| | | Acetone in N₂) | (under | | |
| | | | humid N₂) | | |
| 15 | La_{0.6}Ca_{0.4}Fe_{0.4}Mn_{0.6}O_{3-δ} | 50° C. to 900° C. | 900° C. to | — | — |
| | | at 10° C./min | 50° C. | | |
| | | (under 5% vol H₂ | at −10° C./min | | |
| | | in N₂) | (under 60 sec | | |
| | | | N2 followed | | |
| | | | by Air) | | |
| 16 | La_{0.6}Ca_{0.4}Fe_{0.4}Mn_{0.6}O_{3-δ} | 50° C. to 900° C. | 900° C. to | — | — |
| | | at 10° C./min | 50° C. | | |
| | | (under 5% vol H₂ | at −10° C./min | | |
| | | in N₂) | (under | | |
| | | | Humid N₂) | | |
| 17 | La_{0.6}Ca_{0.4}Fe_{0.4}Mn_{0.6}O_{3-δ} | 50° C. to 900° C. | 900° C. to | — | — |
| | | at 10° C./min | 50° C. | | |
| | | (under 3.7% vol | at −10° C./min | | |
| | | Ethanol) | (under | | |
| | | | Humid N₂) | | |
| 18 | Sr_{0.5}La_{0.5}Fe_{0.5}Ni_{0.25}Ti_{0.25}O_{3-δ} | 50° C. to 900° C. | 900° C. to | 50° C. to | 900° C. to |
| | | at 10° C./min | 50° C. | 900° C. at | 50° C. |
| | | (under 5% vol H₂ | at −10° C./min | 10° C./min | at −10° C./min |
| | | in N₂) | (under | (under | (under |
| | | | Humid N₂) | 5% vol H₂ | 60 sec |
| | | | | in N₂) | N2 |
| | | | | | followed |
| | | | | | by Air) |
| 19 | Sr_{0.5}La_{0.5}Fe_{0.5}Ni_{0.25}Ti_{0.25}O_{3-δ} | 50° C. to 900° C. | 900° C. to | — | — |
| | | at 10° C./min | 50° C. | | |
| | | (under 3.7% vol | at −10° C./min | | |
| | | H₂ in N₂) | (under | | |
| | | | Humid N₂) | | |
| 20 | Cu_{0.25}Co_{0.25}Fe_{2.5}O_{3-δ} | 50° C. to 900° C. | 900° C. to | 50° C. to | 900° C. to |
| | | at 10° C./min | 50° C. | 900° C. at | 50° C. |
| | | (under 5% vol H₂ | at −10° C./min | 10° C./min | at −10° C./min |
| | | in N₂) | (under | (under | (under |
| | | | Humid N₂) | 5% vol H₂ | 60 sec |
| | | | | in N₂) | N2 |
| | | | | | followed |
| | | | | | by Air) |
| 21 | Cu_{0.25}Cu_{0.25}Fe_{2.5}O_{3-δ} | 50° C. to 900° C. | 900° C. to | — | — |
| | | at 10° C./min | 50° C. | | |
| | | (under 3.7% vol | at −10° C./min | | |
| | | Ethanol in N₂) | (under | | |
| | | | Humid N₂) | | |
| 22 | Fe₂O₃ on | 50° C. to 750° C. at | 750° C. to | — | — |
| | Gd_{0.3}Ce_{0.7}O_{2-δ} | 10° C./min | 50° C. | | |
| | | (under 5% vol H₂ | at −10° C./min | | |
| | | in N₂) | (under | | |
| | | | Humid N₂) | | |
| 23 | Fe₂O₃ on | 50° C. to 750° C. at | 750° C. to | — | — |
| | Gd_{0.3}Ce_{0.7}O_{2-δ} | 10° C./min | 50° C. | | |
| | | (under 5% vol | at −10° C./min | | |
| | | H₂, 3.7% vol | in air | | |
| | | Ethanol, | | | |
| | | 3.8% vol | | | |
| | | Acetone, or | | | |
| | | 0.75% vol | | | |
| | | Butanol in N₂) | | | |

### Example 3—Packed Bed Reactor

A system was designed and constructed (see FIG. 35).

A first packed bed reactor was created by inserting 10 g of sample material and 4 g of Al₂O₃ (inert material), all with a particle size of 180-355 micrometres, into the stainless-steel vertical tube (15 mm internal diameter). The tube was placed in the electrically-heated furnace. From the top of the tube, a gas mixture was provided. The gas mixture was created using mass-flow controllers and rotameters, mixing N2, CO, CO2, H2 and air (all BOC), as needed. Water vapour was also used, first vaporising water in a dedicated heated tube. Flowrate of the gas mixture introduced to the reactor was always 350 mL/min. The gas leaving the reactor was directed to ABB analysers (EL3020 and URAS 26) to measure CO, CO2, O2, and H2, or to a second packed bed reactor.

The reactor was heated in a flow of air. The experimental temperature was set using a proportional integral derivative (PID) controller against a temperature reading from a thermocouple positioned in the middle of the material bed. When the setpoint temperature was reached, the gas was changed to N2 for 2 min, then to a gas mixture of the required composition. The internal pressure of the reactor was maintained 1 bar.

The second reactor was the same as the first reactor except that it included a packed bed comprising a second metal oxide material. The resulting gas stream from the second vessel was directed to an analyser.

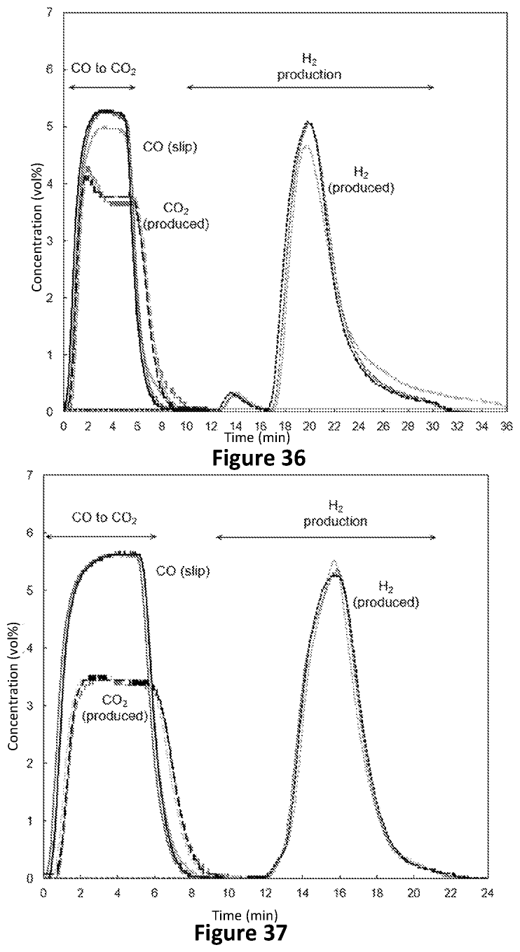

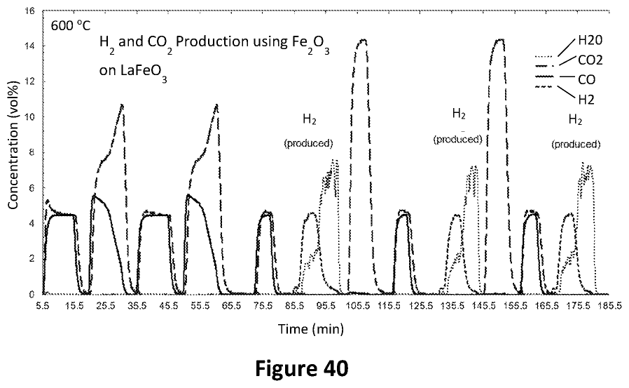

The materials used in the first reactor were the same as those tested in Example 2 and all showed exceptional cyclability, oxidation capability and water splitting (hydrogen production) capability. Of particular note are the materials shown in Table 2 and FIGS. 36 to 40.

TABLE 2

| FIG. | Material | Step I | Step II |
|---|---|---|---|
| 36 | K₂O impregnated Fe₂O₃ | Operating Temperature: | 7% vol H₂O in N₂ |
| | on LaFeO_{3-δ} | 500° C.; | until ~0% vol H₂ |
| | | 9% vol CO in N₂ for 5 | |
| | | min | |
| 37 | Fe₂O₃ on LaFeO_{3-δ} | Operating Temperature: | 7% vol H₂O in N₂ |
| | | 500° C.; | until ~0% vol H₂ |
| | | 9% vol CO in N₂ for 5 | |
| | | minutes | |
| 38 | K₂O impregnated Fe₂O₃ | Operating Temperature: | Oxidation Step: |
| | on LaFeO_{3-δ} | 600° C.; | 7% vol H₂O in N₂ |
| | | 9% vol CO in N₂ for 5 | until ~0% vol H₂ |
| | | minutes | |
| 39 | Fe₂O₃ on LaFeO_{3-δ} | Operating Temperature: | 7% vol H₂O in N₂ |
| | | 600° C.; | until ~0% vol H₂ |
| | | 9% vol CO in N₂ for 5 | |
| | | minutes | |

### FIG. 36:

Average H₂ yield: 75 ml→3.141 mmolH₂
Specific H₂ yield: 0.3141 mmolH₂/gₘₐₜₑᵣᵢₐₗ
Normalised to reduction step duration: 0.06282 mmolH₂/gₘₐₜₑᵣᵢₐₗ/min_{red}.

### FIG. 37:

Average H₂ yield: 60 ml→2.513 mmolH₂
Specific H₂ yield: 0.2513 mmolH₂/gₘₐₜₑᵣᵢₐₗ
Normalised to reduction step duration: 0.05025 mmolH₂/gₘₐₜₑᵣᵢₐₗ/min_{red}

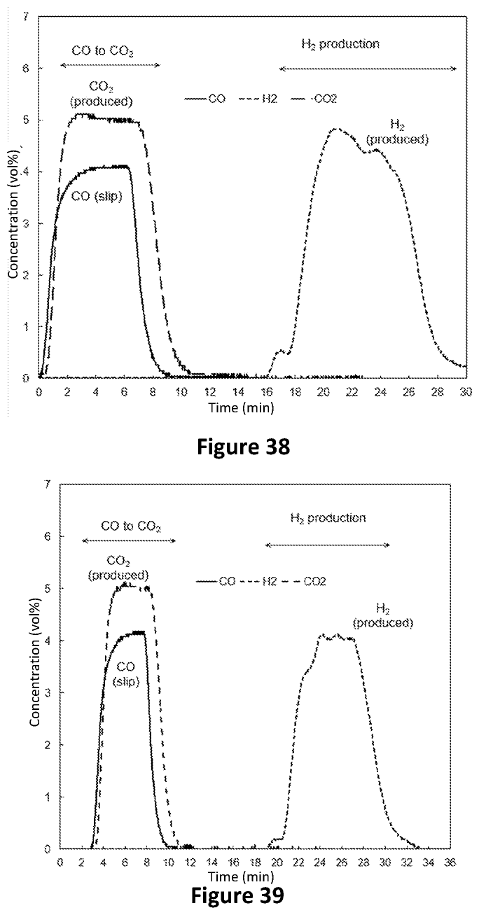

### FIG. 38:

Average H₂ yield: 96 ml→4.020 mmolH₂
Specific H₂ yield: 0.4020 mmolH₂/gₘₐₜₑᵣᵢₐₗ
Normalised to reduction step duration: 0.08040 mmolH₂/gₘₐₜₑᵣᵢₐₗ/minᵣₑ

### FIG. 39:

Average H₂ yield: 93 ml→3.894 mmolH₂
Specific H₂ yield: 0.3894 mmolH₂/gₘₐₜₑᵣᵢₐₗ
Normalised to reduction step duration: 0.07789 mmolH₂/gₘₐₜₑᵣᵢₐₗ/min_{red}

### Modifications

It will be appreciated that many modifications may be made to the embodiments hereinbefore described. Such modifications may involve equivalent and other features which are already known to the skilled person and which may be used instead of or in addition to features already described herein. Features of one embodiment may be replaced or supplemented by features of another embodiment.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicant hereby gives notice that new claims may be formulated to such features and/or combinations of such features during the prosecution of the present application or of any further applications.

1. A system comprising:
a first vessel configured to convert a first fluid into a second fluid, and
a second vessel configured to convert the second fluid into a third fluid,
wherein:
the first vessel comprises an output which is coupled to an input of the second vessel,
the first fluid comprises:
a carbon containing compound,
a hydrogen containing molecule that is not a hydrocarbon, or
a combination of a carbon containing compound and a hydrogen containing molecule that is not a hydrocarbon;
(i) when the first fluid comprises a carbon containing compound:
the second fluid comprises carbon dioxide and at least one impurity;
the third fluid comprises carbon dioxide and optionally at least one impurity; and
the concentration of carbon dioxide in the third fluid is greater than the concentration of carbon dioxide in the second fluid;
(ii) when the first fluid comprises a hydrogen containing molecule that is not a carbon containing compound:
the second fluid comprises water, and at least one impurity;
the third fluid comprises water and optionally at least one impurity; and
the concentration of water in the third fluid is greater than the concentration of water in the second fluid;
(iii) when the first fluid comprises a combination of a carbon containing compound and a hydrogen containing molecule that is not a carbon containing compound:
the second fluid comprises carbon dioxide, water, and at least one impurity;
the third fluid comprises carbon dioxide, water and optionally at least one impurity; and
the concentration of carbon dioxide in the third fluid is greater than the concentration of carbon dioxide in the second fluid.

2. A system according to claim 1, wherein
the first fluid comprises a carbon containing compound;
the second fluid comprises carbon dioxide and at least one impurity;
the third fluid comprises carbon dioxide and optionally at least one impurity; and
the concentration of carbon dioxide in the third fluid is greater than the concentration of carbon dioxide in the second fluid,

3. A system according to claim 1, wherein
the first fluid comprises a hydrogen containing molecule that is not a hydrocarbon;
the second fluid comprises water, and at least one impurity;
the third fluid comprises water and optionally at least one impurity; and
the concentration of water in the third fluid is greater than the concentration of water in the second fluid.

4. A system according to claim 1, wherein
the first fluid comprises a combination of a carbon containing compound and a hydrogen containing molecule that is not a hydrocarbon;
the second fluid comprises carbon dioxide, water, and at least one impurity;
the third fluid comprises carbon dioxide, water and optionally at least one impurity; and
the concentration of carbon dioxide in the third fluid is greater than the concentration of carbon dioxide in the second fluid.

5. A system according to claim 1, wherein the first vessel is a reaction vessel, optionally a combustion vessel.

6. A system according to claim 1, wherein the first vessel comprises an output which is directly coupled to the input of the second vessel.

7. A system according to claim 1, wherein the first vessel comprises a first material which is configured to convert the first fluid into the second fluid.

8. A system according to claim 7, wherein the first material is a metal oxide or a combination of metal oxides; optionally the metal of each of the metal oxides is independently selected from the group consisting of transition metals, lanthanides, and mixtures thereof.

9. A system according to claim 1, wherein the second vessel is a reaction vessel, optionally a combustion vessel such as a chemical looping combustion vessel.

10. A system according to claim 1, wherein the second vessel comprises a second material which is configured to convert the second fluid into the third fluid.

11. A system according to claim 10, wherein the second material is a metal oxide or a combination of metal oxides; optionally the metal of each of the metal oxides is independently selected from the group consisting of transition metals, lanthanides, and mixtures thereof.

12. A system according to claim 1, wherein the first vessel and second vessel are in close proximity; optionally the first vessel and the second vessel are within about 10 metres of each other.

13. (canceled)

14. A system according to claim 1, wherein the carbon containing compound is an organic compound with a boiling point (at standard temperature and pressure) of below about 300° C.

15. A system according to claim 1, wherein the carbon containing compound is selected from the group consisting of substituted or unsubstituted alkanes, substituted or unsubstituted alkenes, substituted or unsubstituted alkynes, substituted or unsubstituted alcohols, substituted or unsubstituted ketones, substituted or unsubstituted aldehydes, substituted or unsubstituted amides, substituted or unsubstituted carboxylic acids, substituted or unsubstituted esters, substituted or unsubstituted carbocyclic compounds, substituted or unsubstituted aromatic compounds, substituted or unsubstituted heteroaromatic compounds, carbon monoxide, carbon dioxide and mixtures thereof.

16. A system according to claim 1, wherein the hydrogen containing molecule that is not a hydrocarbon is selected from the group consisting of hydrogen, ammonia, metal hydrides and mixtures thereof.

17. A system according to claim 1, wherein the first fluid comprises an auxiliary fluid; optionally wherein the auxiliary fluid comprises one or more carrier fluids and/or one or more auxiliary impurities.

18. A system according to claim 1, wherein the at least one impurity is selected from the group consisting of a carbon containing compound, a hydrogen containing molecule that is not a hydrocarbon, an auxiliary fluid and mixtures thereof.

19. A system according to claim 1, wherein the first vessel is configured to operate in a first state or in a second state;
when the first vessel is configured to operate in the first state, the first vessel is configured to convert the first fluid into the second fluid;
when the first vessel is configured to operate in the second state, the first vessel is configured to convert a fourth fluid into a fifth fluid;
wherein
the fourth fluid comprises water; and
the fifth fluid comprises hydrogen.

20. A vessel comprising:
an input,
an output,
a first material, and
a second material;
wherein:
the first material is positioned between the input and the output,
the second material is positioned between the input and the output,
the first material is configured to convert a first fluid into a second fluid,
the second material is configured to convert the second fluid into a third fluid, and
the first fluid comprises:
a carbon containing compound,
a hydrogen containing molecule that is not a hydrocarbon, or
a combination of a carbon containing compound and a hydrogen containing molecule that is not a hydrocarbon;
(i) when the first fluid comprises a carbon containing compound:
the second fluid comprises carbon dioxide and at least one impurity;
the third fluid comprises carbon dioxide and optionally at least one impurity; and
the concentration of carbon dioxide in the third fluid is greater than the concentration of carbon dioxide in the second fluid;
(ii) when the first fluid comprises a hydrogen containing molecule that is not a carbon containing compound:
the second fluid comprises water, and at least one impurity;
the third fluid comprises water and optionally at least one impurity; and
the concentration of water in the third fluid is greater than the concentration of water in the second fluid;
(iii) when the first fluid comprises a combination of a carbon containing compound and a hydrogen containing molecule that is not a carbon containing compound:
the second fluid comprises carbon dioxide, water, and at least one impurity;
the third fluid comprises carbon dioxide, water and optionally at least one impurity; and
the concentration of carbon dioxide in the third fluid is greater than the concentration of carbon dioxide in the second fluid.

21. A process, the process comprising the steps of:
contacting a first fluid with a first material in a first vessel to produce a second fluid, and contacting the second fluid with a second material in a second vessel to produce a third fluid;
wherein:
the first fluid comprises:
a carbon containing compound,
a hydrogen containing molecule that is not a hydrocarbon, or
a combination of a carbon containing compound and a hydrogen containing molecule that is not a hydrocarbon;
(i) when the first fluid comprises a carbon containing compound:
the second fluid comprises carbon dioxide and at least one impurity;
the third fluid comprises carbon dioxide and optionally at least one impurity; and
the concentration of carbon dioxide in the third fluid is greater than the concentration of carbon dioxide in the second fluid;
(ii) when the first fluid comprises a hydrogen containing molecule that is not a carbon containing compound:
the second fluid comprises water, and at least one impurity;
the third fluid comprises water and optionally at least one impurity; and
the concentration of water in the third fluid is greater than the concentration of water in the second fluid;
(iii) when the first fluid comprises a combination of a carbon containing compound and a hydrogen containing molecule that is not a carbon containing compound:
the second fluid comprises carbon dioxide, water, and at least one impurity;
the third fluid comprises carbon dioxide, water and optionally at least one impurity; and
the concentration of carbon dioxide in the third fluid is greater than the concentration of carbon dioxide in the second fluid.

22.-25. (canceled)
